(19) United States
(12) Patent Application Publication
(10) Pub. No.: US 2025/0029060 A1
(43) Pub. Date: Jan. 23, 2025

(54) SYSTEMS AND METHODS FOR PRODUCING A PRODUCT

(71) Applicant: Colgate-Palmolive Company, New York, NY (US)

(72) Inventors: Iraklis Pappas, Pennsauken, NJ (US); Junfang Katy Qian-Pena, Piscataway, NJ (US); Keeyan Haghshenas, Jersey City, NJ (US); John Wolf, New Brunswick, NJ (US); Michael Fitzgerald, Oakhurst, NJ (US); Evan Wireman, Allentown, NJ (US)

(73) Assignee: Colgate-Palmolive Company, New York, NY (US)

(21) Appl. No.: 18/910,396

(22) Filed: Oct. 9, 2024

Related U.S. Application Data
(63) Continuation of application No. 18/546,636, filed on Aug. 16, 2023.
(60) Provisional application No. 63/150,739, filed on Feb. 18, 2021.

(51) Int. Cl. G06Q 10/101

(52) U.S. Cl. CPC G06Q 10/101

(57) ABSTRACT

In one embodiment, the present disclosure is directed to a method for producing a product. For each sample chemical composition of sample chemical compositions, the method inputs into a first model chemoinformatic properties of ingredients of the sample chemical composition, and a value of a property of the sample chemical composition. A new chemical composition is determined via the first model based thereon. The method inputs into a second model, for each sample product of sample products, a value for one or more visual properties of a packaging of the sample product, and one or more characteristics of the new chemical composition. A value is determined for each of the visual properties via the second model. A new product is produced comprising the new chemical composition and packaging comprising the values.

### CROSS-REFERENCE TO RELATED APPLICATION

This application is a continuation of U.S. patent application Ser. No. 18/546,636 filed Aug. 16, 2023, which is a National Stage entry of PCT Patent Application No. PCT/US2022/016767, filed Feb. 17, 2022, which claims the benefit of priority from U.S. Provisional Patent Application No. 63/150,739, filed Feb. 18, 2021, the contents of each are hereby incorporated herein by reference in their entirety.

### BACKGROUND

Many attributes relate to a product. For example, products are formed of compositions, such as chemical compositions. Chemical compositions typically include many different ingredients. Each of the ingredients has a particular value, such as a chemoinformatic value, associated with the ingredient. Further, one or more properties (e.g., a pH, a consumer perception) of the chemical composition may have unique values, for example, based on the ingredients within the composition. The value of the property of the chemical composition may change due to the interaction of the ingredients within the composition. Products may also have attributes in addition to its ingredients, such as sensory attributes of the product and/or packaging of the product. Sensory attributes may include consistencies of the product, text of the packaging of the product, and colors of the product and packaging of the product. Such sensory attributes may be influential in the purchase of the product, and, therefore, may result in the market value of the product.

Conventional methods exist for predicting attributes of a product, such as ingredients of the product, colors of the product and packaging of the product, and text that is provided on packaging of the product. Such methods, however, are often time consuming and nontrivial. Thus, a system and/or method is desired that can determine an attribute of a product(s), a product portfolio(s), and/or a product portfolio in a way/ways that requires less time and/or less complexity.

### BRIEF SUMMARY

A system, apparatus, and/or method is disclosed. In one aspect, one or more financial characteristics relating to a sample product may be received. The one or more financial characteristics relating to the sample product may be received for each sample product of sample products belonging to a product category. For each of the sample products, a value for each of one or more respective properties of the sample product may be received. The one or more respective properties of the sample product may include at least one of a sensory attribute relating to the sample product or a phrase relating to the sample product. The received values of the one or more respective properties of the sample products and the one or more received financial characteristics relating to the sample products may be input into a machine learning model. A desired financial characteristic for a potential product in the product category may be input into the machine learning model. A value for each of the one or more respective properties for the potential product may be determined (e.g., determined via the machine learning model) based on the desired financial characteristic for the potential product. A product having the determined value for each of the one or more respective properties for the potential product may be produced.

In another aspect, one or more identities of ingredients forming a sample product may be received. The one or more identities may be received for each sample product of sample products belonging to a product category. For each of the sample products, one or more financial characteristics of the sample product may be received. The one or more financial characteristics of the sample product may include at least one of a profitability relating to the sample product, a market value relating to the sample product, or a market share relating to the sample product. The one or more received financial characteristics of the sample products and the received identities of the ingredients forming the sample products may be input into a machine learning model. Desired identities of ingredients forming a potential product in the product category may be input into the machine learning model. A value for each of the one or more financial characteristics for the potential product may be determined via the machine learning model based on the desired identities of the ingredients forming the potential product. A product including the determined identities of the ingredients for the potential product may be produced.

In another aspect, one or more identities of ingredients forming a sample product may be received for each sample product of sample products belonging to a product category. For each of the sample products, a value for each of one or more respective properties of the sample product may be received. The one or more respective properties of the sample product may include at least one of a sensory attribute relating to the sample product or a phrase relating to the sample product. The received values of the one or more respective properties of the sample products and the received identities of the ingredients forming the sample products may be input into a machine learning model. A desired value for each of the one or more respective properties for a potential product may be input into the machine learning model. Identities of ingredients for forming the potential product may be determined via the machine learning model based on the desired value for each of the one or more respective properties of the potential product. A product including the determined identities of the ingredients for forming the potential product may be produced.

In another aspect, a device may be configured to receive, for each sample product of sample products belonging/corresponding to a product category, one or more financial characteristics relating to a sample product. The device may be configured, perhaps for each of the sample products, to receive a value for each of one or more respective properties of the sample product. The one or more respective properties of the sample product may comprise at least one of a sensory attribute relating to the sample product, or a phrase relating to the sample.

The device may be configured to receive an input, into at least one machine learning model, the received values of the one or more respective properties of the sample products and the one or more received financial characteristics relating to the sample products. The device may be configured to receive an input, into the machine learning model, of a first desired financial characteristic for a first potential product in the product category. The device may be configured to determine, via the machine learning model, a first value for each of the one or more respective properties for the first potential product, perhaps based on the first desired financial characteristic for the first potential product. The device may be configured to order production of at least a first product and/or the at least a first product may be produced. The product may comprise the determined first value for each of the one or more respective properties for the first potential product. The receiving, inputting, ordering, and/or determining steps may be performed by one or more processors of the device/devices, such as one or more processors housed in a server, a mobile device, and/or the like, for example.

The device may be configured to receive an input, into the machine learning model, of a second desired financial characteristic for a second potential product in the product category. The device may be configured to determine, via the machine learning model, a second value for each of the one or more respective properties for the second potential product, perhaps based on the second desired financial characteristic for the second potential product. The device may be configured to order the production of at least a second product, and/or the at least second product may be produced. The at least second product may comprise the determined second value for each of the one or more respective properties for the second potential product. The device may be configured to order the production of at least a part of a product category portfolio and/or the product category portfolio may be produced. The product category portfolio may comprise at least the first product and the second product, for example.

In another aspect, a device may be configured to receive, for each sample product of sample products belonging to a product category, one or more identities of ingredients forming the sample product. The device may be configured, perhaps for each of the sample products, to receive one or more financial characteristics of the sample product. The one or more financial characteristics of the sample product may comprise at least one of a profitability relating to the sample product, a market value relating to the sample product, and/or a market share relating to the sample.

The device may be configured to receive an input, into a machine learning model, the one or more received financial characteristics of the sample products and the received identities of the ingredients forming the sample products. The device may be configured to receive an input, into the machine learning model, of a first desired identities of ingredients forming a first potential product in the product category. The device may be configured to determine, via the machine learning model, a first value for each of the one or more financial characteristics for the first potential product, perhaps based on the first desired identities of the ingredients forming the first potential product. The device may be configured to order production of at least a first product and/or the at least a first product may be produced. The product may comprise the determined first value for each of the one or more financial characteristics for the first potential product. The receiving, inputting, ordering, and/or determining steps may be performed by one or more processors of the device/devices, such as one or more processors housed in a server, a mobile device, and the like, for example.

The device may be configured to receive an input, into the machine learning model, of a second desired identities of ingredients forming a second potential product in the product category. The device may be configured to determine, via the machine learning model, a second value for each of the one or more financial characteristics for the second potential product, perhaps for example based on the second desired identities of ingredients forming the second potential product. The device may be configured to order the production of at least a second product, and/or the at least second product may be produced. The at least a second product may comprise the determined second value for each of the one or more financial characteristics for the second potential product. The device may be configured to order the production of at least a part of a product category portfolio and/or the product category portfolio may be produced. The product category portfolio may comprise at least the first product and the second product, for example.

In another aspect, a device may be configured to receive, for each sample product of sample products belonging to a product category, one or more identities of ingredients forming the sample. The device may be configured, perhaps for each of the sample products, to receive a value for each of one or more respective properties of the sample product. The one or more respective properties of the sample product may comprise at least one of a sensory attribute relating to the sample product and/or a phrase relating to the sample product.

The device may be configured to receive an input, into a machine learning model, of the received values of the one or more respective properties of the sample products and the received identities of the ingredients forming the sample products. The device may be configured to receive an input, into the machine learning model, of a desired first value for each of the one or more respective properties for a first potential product. The device may be configured to determine, via the machine learning model, a first identities of ingredients for forming the first potential product, perhaps based on the desired first value for each of the one or more respective properties of the first potential product. The device may be configured to order production of at least a first product and/or the at least a first product may be produced. The first product may comprise the first determined identities of the ingredients for forming the first potential product. The receiving, inputting, ordering, and/or determining steps may be performed by one or more processors of the device/devices, such as one or more processors housed in a server, a mobile device, and the like.

In another aspect, the device may be configured to receive an input, into the machine learning model, a desired second value for each of the one or more respective properties for a second potential product. The device may be configured to determine, via the machine learning model, a second identities of ingredients for forming the second potential product, perhaps based on the desired second value for each of the one or more respective properties of the second potential product. The device may be configured to order production of at least a first product and/or the at least a first product may be produced. The at least second product may be comprised of the second determined identities of ingredients for forming the second potential product. The device may be configured to order the production of at least a part of a product category portfolio and/or the product category portfolio may be produced. The product category portfolio may comprise at least the first product and the second product, for example.

In another aspect, a device may be configured to receive, for each sample product of sample products one or more financial characteristics relating to the sample product. The device may be configured, perhaps for each of the sample products, to receive a value for each of one or more respective properties of the sample product. The one or more respective properties of the sample product may comprise at least one of a sensory attribute relating to the sample product and/or a phrase relating to the sample product.

The device may be configured to receive an input, into a machine learning model, of the received values of the one or more respective properties of the sample products and the one or more received financial characteristics relating to the sample products. The device may be configured to receive an input, into the machine learning model, of a desired financial characteristic for a potential product portfolio. The device may be configured to determine, via the machine learning model, perhaps based on the desired financial characteristic for the potential product portfolio one or more potential products for the potential product portfolio, and/or a first value for each of the one or more respective properties for each of the one or more determined potential products for the potential product portfolio. The device may be configured to order production of at least a first product and/or the at least a first product may be produced. The first product may comprise the determined first value for each of the one or more respective properties for a first potential product. The receiving, inputting, ordering, and/or determining steps may be performed by one or more processors of the device/devices, such as one or more processors housed in a server, a mobile device, and the like.

### BRIEF DESCRIPTION OF THE DRAWINGS

The present invention will become more fully understood from the detailed description and the accompanying drawings, wherein:

FIG. 1A is a table of ingredients of an example composition;

FIG. 1B is a table of example properties of composition in which consumers may have a perception;

FIG. 2A is a block diagram of example components of a composition, the components including ingredients and substances of the composition;

FIG. 2B is a table of ingredients of another example composition, providing identities of the ingredients and percentages of the ingredients;

FIG. 2C is a block diagram of example components of a product, the components including financial data relating to the product;

FIG. 2D is a table of attributes relating to the product, the attributes including sensory and non-sensory attributes;

FIG. 3A is an example process for determining a value of a composition using machine learning rules;

FIG. 3B is an example system for determining a value of a composition;

FIG. 4 is another example process for determining a value of a composition using machine learning rules;

FIG. 5 is a block diagram of an example system including a user device;

FIG. 6 is a block diagram of an example system including a training of a property engine;

FIG. 7 is a table of example functions of ingredients of a composition;

FIG. 8 is a table of example classifications of ingredients of a composition;

FIGS. 9A, 9B, 9C are block diagrams of an example training of a machine learning model and receiving values from the machine learning model;

FIGS. 10A, 10B, 10C are example graphical user interfaces (GUIs) for training a property engine;

FIGS. 11A, 11B, 11C, 11D are example graphical user interfaces (GUIs) for receiving a determined value via a property engine;

FIG. 12 is an example method of determining values of a composition, as described herein;

FIG. 13 is another example method of determining values of a composition, as described herein;

FIG. 14 is a block diagram of an example system in which data is provided from multiple sources and presented at a single source;

FIG. 15 is an example method for determining properties of a product;

FIG. 16 is an example method for determining properties of a product;

FIG. 17 is an example method for determining properties of a product;

FIG. 18 is an example method for determining properties of a product; and

FIG. 19 is an example method for determining properties of a product and/or a product portfolio.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

A product may be a composition that includes one or more attributes. A composition may include one or more ingredients (e.g., components). For example, a composition may include a first, second, third, etc. ingredient. One or more of the ingredients of a composition may have an effect on one or more other ingredients of the composition. Also, or alternatively, one or more of the ingredients may have an effect on the composition (e.g., the composition as a whole).

A composition may be a chemical composition, although in some embodiments a composition may be a non-chemical composition. The composition may form a product. The composition (e.g., a product formed from the chemical composition) may be used for one or more purposes. For example, a product formed from a chemical composition may be used for cooking; cleaning; consumption, personal care; treating/testing for diseases, disorders, conditions; as well as one or more other purposes. A composition (e.g., chemical composition) may be used for performing tasks. For example, a chemical composition may be used for performing tests, such as water purity tests.

A product (e.g., a personal care product) may be formed of a chemical composition. Although a personal care product may be described throughout the specification, it should be understood that a product being a personal care product is for illustration purposes only and a chemical composition may form one or more other products, such as a foodstuff, a pharmaceutical, and the like.

A personal care product may exist for enhancing a user's health, hygiene, appearance, smell, etc. Such personal care products may comprise one or more chemical compositions that are comprised of one or more ingredients. Personal care products may include oral care products comprising oral care compositions, skin care products comprising skin care compositions, hair care products comprising hair care compositions, as well as other products and/or chemical compositions.

Oral care composition, as used herein, may include a composition for which the intended use can include oral care, oral hygiene, oral appearance, or for which the intended use may comprise administration to the oral cavity. Skin care composition, as used herein, may include a composition for which the intended use may include promotion or improvement of health, cleanliness, odor, appearance, and/or attractiveness of skin. Hair care compositions, as used herein, may include a composition for which the intended use may include promotion or improvement of health, cleanliness, appearance, and/or attractiveness of hair. The compositions may be used for a wide variety of purposes, including for enhancing personal health, hygiene, and appearance, as well as for preventing or treating a variety of diseases and other conditions in humans and in animals.

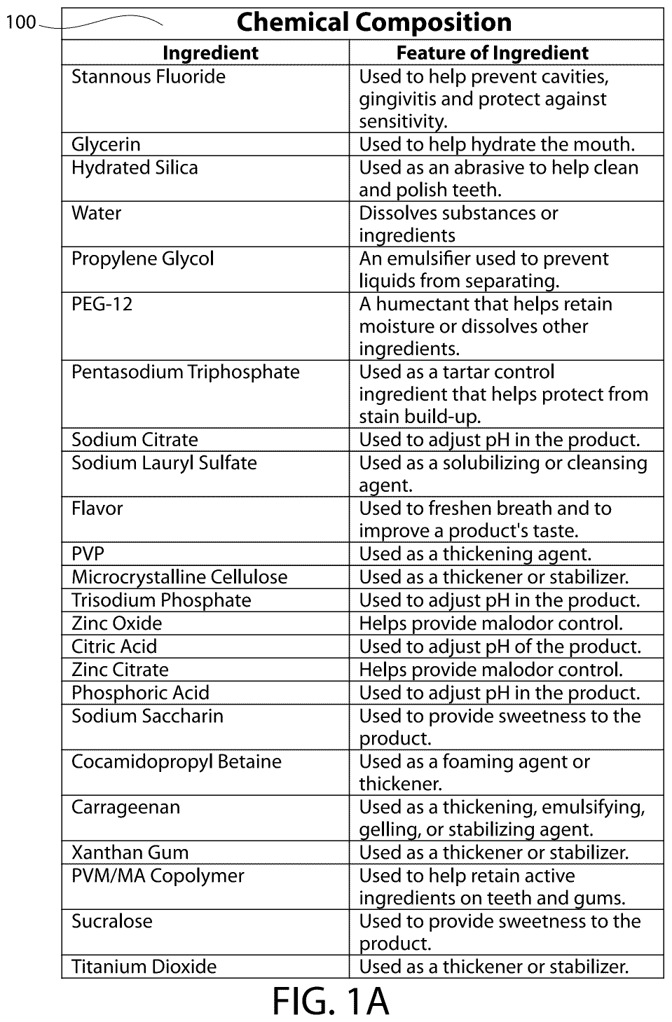

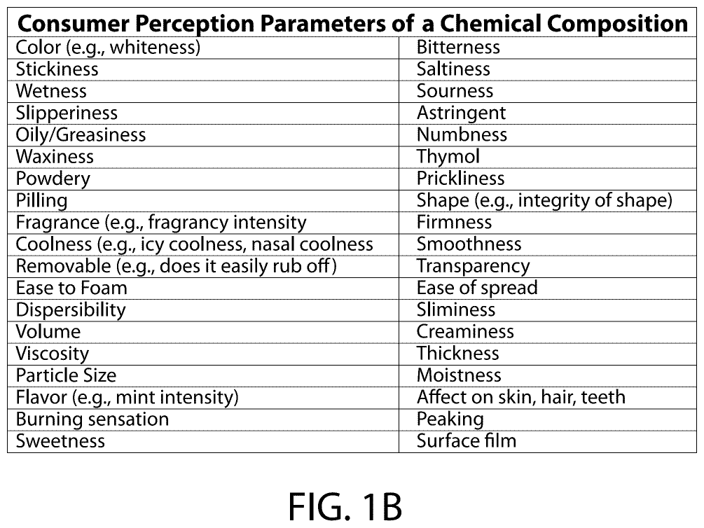

FIG. 1A shows a table of example data associated with one or more compositions. The composition may be a chemical composition, such as chemical composition 100. Chemical composition 100 may form a product, such as a personal care product. As can be seen from FIG. 1A, chemical composition 100 may include several ingredients. For example, chemical composition 100 may include glycerin, sodium lauryl sulfate, zinc citrate, as well as one or more other ingredients. Each of the ingredients of the chemical composition 100 (e.g., the chemical composition forming a personal care product) may be included in the personal care product to provide one or more predefined features. As provided in FIG. 1A, features of the ingredients may include providing sweetness to the chemical composition 100, providing stabilizing factors to the chemical composition 100, etc. For example, sodium lauryl sulfate is an ingredient of the chemical composition 100 that may be used as a solubilizing or cleansing agent for the chemical composition 100.

FIG. 1B shows a table of additional data (e.g., example data) associated with an example composition, such as chemical composition 100. In an example the chemical composition may form a product, such as a personal care product, a foodstuff, a pharmaceutical, etc. The chemical composition may form a product that is used, consumed, sold, purchased, etc., by humans, animals, and/or other material. For example, the chemical composition may form a skin care product used by a person or an animal, a foodstuff consumed by a person or an animal, a pharmaceutical used to treat a human and/or an animal, etc. In other examples the composition may be a chemical composition used to clean one or more surfaces, a composition used to absorb one or more fluids, and the like.

Attributes of a product may relate to financial aspects relating to the product. For example, attributes of a product may relate to the profitability, market value, market share, and the like of a product. Attributes of the product may be sensory attributes of the product and/or sensory attributes of the packaging associated with the product. Sensory attributes may relate to the look (e.g., color, size, shape), feel, taste, smell, or sound of a product. Attributes of the product may relate to non-sensory attributes of the product, such as text associated with the product. Text associated with the product may include words on the packaging of the product or on the product itself.

A product may sell better, or worse, based on the attributes of the product and/or packaging of the product. For example, a product may sell better, or worse, based on the consistency of the product, the smell of the product, the taste of the product, the sound that the product and/or packaging of the product makes during use, etc. The product may sell better, or worse, based on branding or marketing associated with the product. For example, a product may sell better, or worse, based on the color of the product and/or packaging of the product, the text used on the packaging of the product, a shape of the product and/or packaging of the product, a material of the packaging of the product. The product may sell better, or worse, based on the ingredients used for the product. Attributes that result in a first product selling better may result in a second product selling better, or worse. For example, it may be found that a pumpkin ingredient causes a first product to sell better and a second product to sell worse.

A user and/or purchaser of a product (e.g., a personal care product, a foodstuff, a pharmaceutical, etc.) may perceive the product in a particular manner. FIG. 1B provides example data that may relate to a perception of a product, such as a personal care product, a foodstuff, and/or a pharmaceutical, although other uses may be envisioned. The perception of the product may be determined (e.g., derived) via a consumer of the product, a clinical trial of the product, etc. The perception of the product may be determined (e.g., derived) from social media sources. For example, the perception of the product may be determined (e.g., derived) from content provided by social media sources, such as from social media marketing. The perception of the product may be determined (e.g., derived) via trends (e.g., trends provided via social media sources), blogs, descriptors (e.g., hash tags provided via social media sources), and the like.

The perception of the product may be determined (e.g., derived) from influencers, such as from celebrities, athletes, musicians, social media influencers, product experts, and the like. For example, the perception of the product may be determined (e.g., derived) from a professional endorsement, such as an endorsement by a dentist, dermatologist, veterinarian, and the like. The perception of the product may be determined (e.g., derived) from one or more other types of marketing materials, such as television advertisements, print advertisements (e.g., magazine advertisements, newspaper advertisements), website advertisements, and the like. The perception of the product may correlate with a profitability of the product, the market share of the product, the market value of the product, etc. For example, users having a positive perception of a product may result in the product selling for a higher profitability, for a higher market value, and/or having a higher market share.

FIG. 1B shows an example in which a consumer may perceive a chemical composition according to several categories and/or features. For example, consumers may have perceptions about the color, stickiness, wetness, case of use, sweetness, etc., of a chemical composition. A consumer may have a preference for a personal care product based on the perception of one or more features of the chemical composition forming the personal care product. For example, a consumer may prefer that a toothpaste have a certain color, that a shampoo have a certain smell, that a deodorant have a certain dispersibility, etc. Personal care products aligning with customer preferences may result in the product being more profitable, having a higher market value, and/or obtaining a greater market share. Conversely, personal care products not aligning with customer preferences may result in the product being less profitable, having a lower market value, and/or obtaining a lower market share.

Personal care products may be rated by one or more consumers and/or users of a product (e.g., personal care product). The consumers and/or users may rate the product based on one or more perception values that the consumer has regarding the personal care product. The values of consumer perceptions may be obtained in a variety of ways, including a survey (e.g., a paper or online survey), a clinical trial (e.g., a clinical trial measuring outcomes of use of the chemical composition over a period of time), storage conditions of the product (e.g., the environment in which the product is stored), commercial success of the product, etc. For example, while a product that exhibits a great amount of commercial success (e.g., high profitability, large market share, high market value) is likely to be positively perceived by a user and/or consumer of the product, a product that exhibits a small amount of commercial success is likely to be negatively perceived by a user and/or consumer of the product.

Commercial success of a product may be defined over one or more areas. For example, commercial success of a product may be defined over one or more regions, one or more seasons, one or more demographics, one or more biomarkers of users of the product, and the like. For example, a product may exhibit great commercial success at a first region and poor commercial success at a second region; may exhibit great commercial success at a first season and poor commercial success at a second season; and/or may exhibit great commercial success with a first demographic and poor commercial success with a second demographic. Examples of demographics are provided herein.

Clinical trials may be used to determine the outcomes of uses of one or more chemical compositions. Clinical outcomes may be measured over a period of time. For example, with respect to personal care products, clinical outcomes may relate to a gingivitis reduction, a tooth whitening, a sensitivity relief, a wrinkle reduction, etc., over a period of time. Examples may include a gingivitis reduction being measured over a three or six month use of a chemical composition, a tooth whitening being measured over a several day/month use of a chemical composition, a sensitivity relief being measured over a several minute/month use of a chemical composition, and/or a wrinkle reduction being measured over a ninety-day use of a chemical composition. Although clinical outcomes and periods of time may relate to personal care products, clinical outcomes may be measured for chemical compositions other than personal care products, such as for foodstuffs (e.g., human or animal foodstuffs), pharmaceuticals, etc. As an example, a reduction of an animal's weight (e.g., an animal's weight, such as a canine's weight) may be measured over a month's use of a pet food, a reduction of a health condition (e.g., a human or animal's health condition) may be measured over a six month's use of a pharmaceutical, etc.

Clinical outcomes may relate to a formulation attribute. Formation attributes may result from chemical interactions of the chemical composition forming the product. For example, with respect to a tooth whitening, an oxidation potential of the product may be an attribute (e.g., formulation attribute) that impacts the speed and extent to which the product whitens teeth. With respect to abrasivity of a product, a pellicle cleaning ratio (PCR) may be an attribute that impacts the speed and/or extent of whitening outcomes. With respect to dental carries, a state (e.g., a desired state) in a chemical composition may be an attribute that relates to how fluoride interacts with one or more other ingredients. The desired state in a chemical composition may correspond to fluoride having minimal interactions with excipient ingredients, which may yield more fluoride (e.g., free fluoride). With respect to acne, anti-inflammatory properties may impact the efficacy of a chemical composition.

Example data may include data other than the data provided in FIGS. 1A and 1B. The example data may include user-related information, such as demographic information, biomarker data, and the like. Demographic information may include geographic information relating to a user of a product (such as current/previous residence information of the user of the product), ancestry of the user of the product, age/height/weight/body mass index of the user of the product, body hair coverage of the user of the product, bodily sweat production of the user of the product, skin sebum production of the user of the product, biomarkers (e.g., the presence/absence of biomarkers of the user of the product), genetic states (e.g., as defined by single variants, multiple variants or combinations thereof, including the entirety of user's genome), hair type/color of the user of the product, skin pH of the user of the product, the nutrition of the user of the product, the exercise regimen of the user of the product, bodily micro-flora of the user of the product, current/past heath conditions and/or states of the user of the product, and the like.

Biomarkers may include a substance (e.g., measurable substance) of a person or animal that is indicative of a phenomenon, such as a disease, an infection, an environmental exposure, or the like. Additional example data may include physical characteristics of a user (e.g., skin type, such as dryness or oiliness of the user's skin); effects of the chemical composition on the skin; the presence of tattoos and/or blemishes on the skin; skin elasticity; skin health, color pigmentation of the skin; skin age (actual and/or perceived); the number of visits to a dermatologist; the use of sun protection; the use of moisturizer(s); etc. Example data may include behavioral patterns such as activity, motility, and one or more other quantifiable behavioral attributes.

Example data may include ways in which a product interacts with the environment. The degree and/or the ways in which a product interacts with the environment may determine chemical reactions of the product, as described herein. For example, data associated with the product may include whether one or more of the chemical compositions forming the product impact the kinetics of a chemical reaction of the product. Also, or alternatively, data associated with the product may include whether one or more of the chemical compositions forming the product impact the kinetics of a phase transformation of the product, where phase transformations may include a volatile evaporation, phase transition, etc.

Data associated with a product may include other environmental attributes of the chemical composition forming the product. Data associated with a product may include the stability of the chemical composition forming the product and/or attributes relating to the storage of such product. For example, chemical reactions of a product may be affected by storage temperature, storage humidity, and the like. As an example, chemical reactions of chemical compositions may be accelerated when the chemical composition is stored at a higher temperature and/or at a higher humidity. Example data may include the packaging of the product. For example, the packaging of the product may determine the degree and/or the ways in which the product interacts with the environment. Examples of packaging may include packaging material composition, packaging geometry, packaging opacity, etc. Example data may include a form factor of the product having the chemical composition. For example, data may include whether a chemical composition of a soap is in solid (e.g., bar) form or liquid form.

Example data may include consumer perceptions of the product formed of the chemical composition. Consumer perceptions of a chemical composition (e.g., a chemical composition forming a personal care product, foodstuff, pharmaceutical, etc.) may be based on one or more of the ingredients of the product. For example, a consumer perception value may be affected by one or more ingredients of the product, such as a particular ingredient causing a personal care product to be more white or less white, to be more sticky or less sticky, to cause more of a burning sensation or less of a burning sensation, etc.

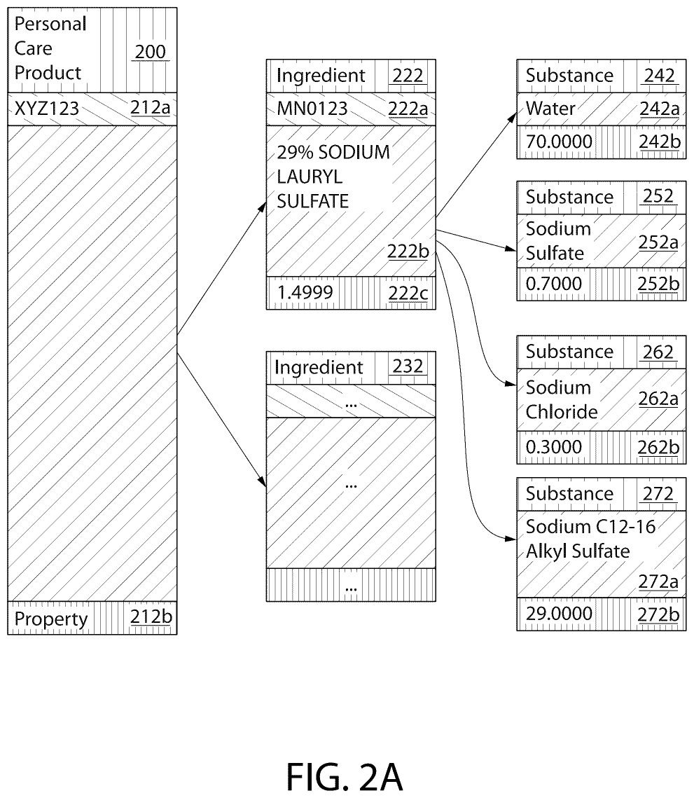

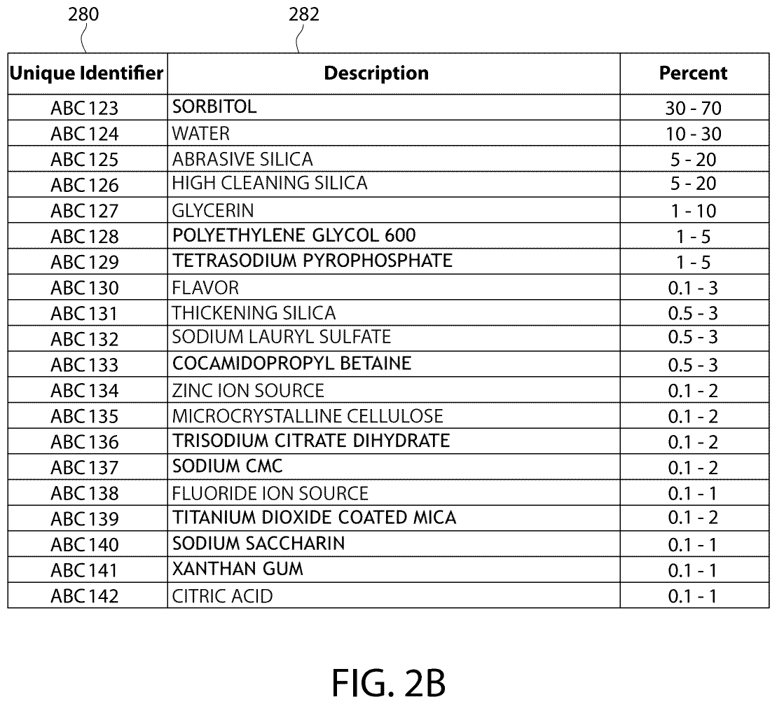

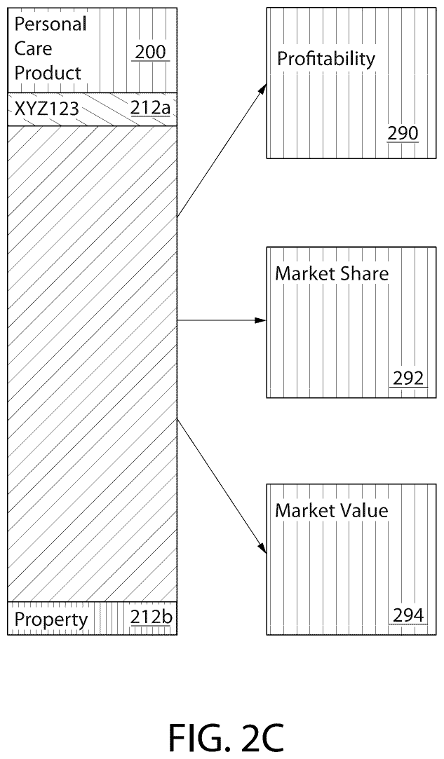

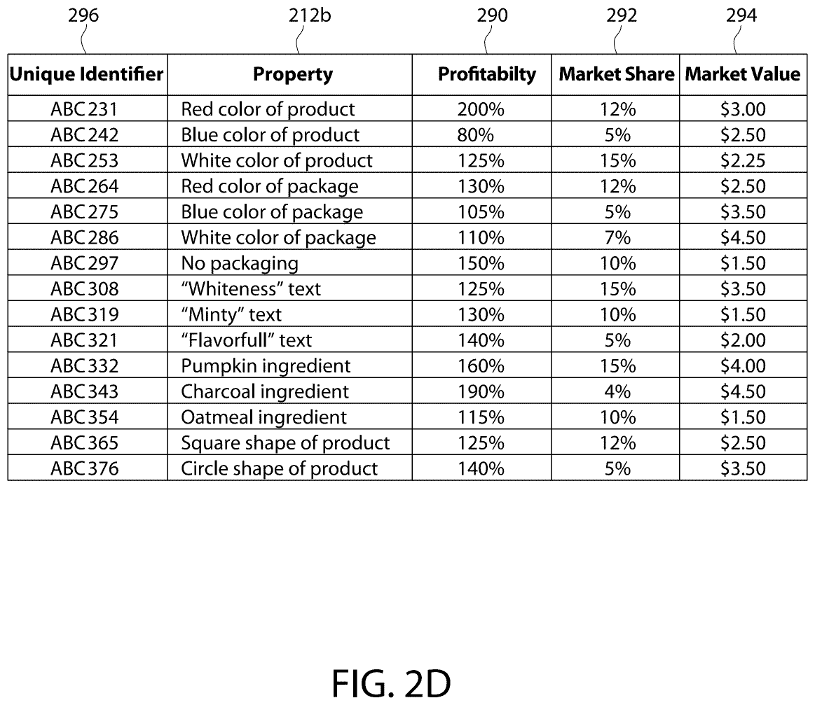

FIG. 2A shows a depiction of example data that may be associated with a composition (e.g., a chemical composition of a product). Although many of the examples provided herein describe a composition forming a personal care product, such examples are for illustration purposes only and are non-limiting. The composition may form a variety of products, such as a personal care product 200, a foodstuff, a pharmaceutical, etc.

Data associated with a product, such as personal care product 200, may include an identity (such as a name of the personal care product), ingredients of the personal care product, chemoinformatic values of ingredients of personal care product, clinical trial and/or clinical outcome information of the personal care product, user-related information (e.g., demographic information) of the personal care product, formulation attributes of the personal care product, sensory attributes relating to a product, phrases relating to a product and/or packaging of a product, or one or more other identifiers used to identify the personal care product.

A product, such as personal care product 200, may be associated with a unique number 212a that may be referenced by a user and/or computer when referring to the personal care product. Each personal care product 200 may have one or more other values and/or properties, such as one or more properties 212b. Property 212b may be a chemical property associated with the chemical composition of the personal care product, a sensory attribute (e.g., color, size, shape, taste, smell, sound, etc.) associated with the personal care product, a non-sensory attribute (e.g., phrase) associated with the personal care product, and the like. As an example, property 212b may be a physiochemical property of the chemical composition of the personal care product. The physiochemical property of the chemical composition may relate to a physical property or a chemical property of the chemical composition of the personal care product.

Property 212b may be a pH value of the personal care product and/or one or more other pieces of data, such as the example data provided herein. For example, property 212b may be clinical trial and/or clinical outcome data, user-related data, product form factor and/or packaging data, shelf-life data, biomarker data, formulation attribute data, and the like. Property 212b may be a consumer perception of the personal care product, such as the perceptions shown in FIG. 1B. For example, consumers may have perceptions about the color, stickiness, wetness, case of use, sweetness, etc., of the personal care product. The consumer perceptions of the personal care product may be based on one or more of the ingredients of the personal care product. For example, an ingredient may cause a personal care product to be more white or less white, to be more sticky or less sticky, to cause more of a burning sensation or less of a burning sensation, etc. The value of property 212b may be affected by one or more ingredients of the personal care product.

As described herein, a composition (e.g., chemical composition) may form a product, such as a personal care product, foodstuff, pharmaceutical, and the like. The chemical composition may be comprised of one or more ingredients (e.g., ingredient data), such as ingredients 222, 232. Each ingredient may include an identity, such as a name of the ingredient or other identifier used to identify the ingredient. For example, ingredient 222 may include a name 222b and/or an identifier 222a. Ingredient 222 may include other information, such as the percentage of the personal care product that comprises the ingredient. For example, as shown in 222c, ingredient 222 (e.g., sodium lauryl sulfate) may be 1.4999% of the personal care product 200. Ingredient data may include one or more other properties and/or values of the properties.

Each ingredient may be made up of one or more substances. As shown in FIG. 2A, ingredient 222 may be comprised of four substances: water 242, sodium sulfate 252, sodium chloride 262, and sodium C12-16 Alkyl Sulfate 272. Data may be associated with one or more (e.g., each) of the substances. For example, each substance may include an identity, such as a name 242a, 252a, 262a, 272a of the substance or other identifier used to identify the substance. As an example, substance 242 may have a name 242a of water. The substance (such as substance 242, 252, 262, 272) may include one or more other values, such as the percentage 242b that the substance makes up of the ingredient, chemoinformatic properties of the ingredients (e.g., substances of the ingredients), etc. For example, substance 242 (i.e., water) may comprise 70% of the ingredient 222 sodium lauryl sulfate, as shown on 242b. Substance 272 may include chemoinformatic properties such as a chemical class, a surface area (e.g., topological polar surface area), a qualitative category, a qualitative sensory attribute, a molecular formula, an acid dissociation constant, a solubility product, a structural topology, a functional group count, a chemical fragment count, a hydrophobicity, a partition coefficient, a steric parameter, an association constant, a hydrophile lipophile balance (HLB) value, etc. The qualitative category may include an ingredient function or an ingredient classification. As shown on FIG. 2A, example information may include a chemical class of Alkyl Sulfate, an HLB value of 40, and/or a topological polar surface area of 74.8 squared Angstroms. In other examples, however, one or more substances may have one or more (e.g., different) chemoinformatic properties having one or more different values.

As described herein, property 212b of personal care product may be affected by interactions of one or more of the ingredients of the chemical composition forming the product, such as personal care product 200, foodstuff, and/or pharmaceutical. Examples of property 212b may relate to a pH, fluoride (e.g., fluoride stability), viscosity (e.g., viscosity stability), viscoelasticity, abrasion (e.g., stain removal and dentin abrasion), color, turbidity, analyte concentration, specific gravity, clinical trial and/or clinical outcome information, consumer usage information (e.g., user-related information, such as demographic information), product form factor information, packaging information, biomarker information, consumer perception (e.g., sweetness, stickiness, fragrance), etc., of a product, such as a personal care product.

A value of property 212b may be based on a feature relating to the property, such as a particular time period. For example, property 212b may relate to outcomes of a teeth whitening clinical study at one or more time periods, such as clinical outcomes at two weeks, four weeks, six weeks, eight weeks, etc. As another example, the efficacy (e.g., clinical efficacy) of a fluoride, such as bioavailable fluoride, may be based on a time period. The time period may be days, weeks, months, years, or the like. As another example, a bioavailable fluoride in a toothpaste may decay from 1400 parts per million (ppm) to 1100 ppm over a two-year period. Property 212b may include the bioavailable fluoride in a toothpaste at the beginning of the shelf life of the toothpaste (e.g., when the fluoride level is at 1400 ppm) and/or at the end of the shelf life of the toothpaste (e.g., when the fluoride level is at 1100 ppm).

As described herein, the value of property 212b may be determined via clinical trials, observations (e.g., clinical observations), market data, survey information, and the like. The value of property 212b of the chemical composition of the product (e.g., personal care product) may be determined by experimentally measuring the value of the property. For example, by experimentally measuring the property of the product, the actual value of the property may be determined. The value of the property 212b may be determined via a mathematical (e.g., thermodynamic) calculation of the value of the property. As an example, a database of personal care product compositions may be compiled. The compositions may include one or more compositions. A catalogue (e.g., a hand-evaluated catalogue) may contain one or more constants (e.g., metal binding constants, surface acidity constant, etc.), and/or one or more solubility products, for example. Speciation calculations may be performed on personal care product compositions. The speciation calculations may be used to determine the activity of one or more (e.g., each) ion of a personal care product composition. The negative log of the hydrogen ion may correspond (e.g., activity correspond) to a calculated value (e.g., the calculated pH value) of the personal care product composition.

The value of the property 212b may be determined by performing clinical and/or consumer trials providing identified results or perceptions of one or more attributes of the personal care product. For example, clinical and/or consumer trials may be used to determine consumer perceptions about the personal care product. The trials may determine how consumers (e.g., potential consumers) may perceive the personal care product. For example, clinical and/or consumer trials may determine how consumers feel about the color (e.g., whiteness, redness, blueness), stickiness, wetness, sweetness, fragrance, bitterness, case of use, etc. of the personal care product. Consumer perceptions may be determined via other methods, including surveys (e.g., online and paper surveys), commercial success, etc. The value of the property resulting from clinical and/or consumer trials may be based on features relating to the property, such as the time period of the clinical/consumer trial, user-related information of the participants of the clinical/consumer trial, environmental factors in which the clinical and/or consumer trial is performed, and the like. FIG. 1B provides a list of example properties of personal care product in which consumers may have a perception.

As described herein, a product (e.g., personal care product 200) may be associated with a unique number 212a that may be referenced by a user and/or computer when referring to the personal care product. Each personal care product 200 may have one or more other values and/or properties, such as one or more properties 212b. Property 212b may be a sensory attribute associated with the personal care product, a non-sensory attribute (e.g., phrase) associated with the personal care product, financial characteristics associated with the personal care product, and the like. As an example, property 212b may be a physiochemical property of the chemical composition of the personal care product. The physiochemical property of the chemical composition may relate to a physical property or a chemical property of the chemical composition of the personal care product.

Property 212b may be a pH value of the personal care product and/or one or more other pieces of data, such as the example data provided herein. For example, property 212b may be clinical trial and/or clinical outcome data, user-related data, product form factor and/or packaging data, shelf-life data, biomarker data, formulation attribute data, and the like. Property 212b may be a consumer perception of the personal care product, such as the perceptions shown in FIG. 1B. For example, consumers may have perceptions about the color, stickiness, wetness, case of use, sweetness, etc., of the personal care product.

Property 212b may be an efficacy of the product and/or a perception of the efficacy of the product. For example, property 212b may include shades of whitening that a toothpaste is marketed to provide. As another example, property 212b may include shades of whitening that a consumer perceives the toothpaste providing versus the shades marketed by the toothpaste to provide. The consumer perceptions, efficacies, and/or perceptions of efficacy of the personal care product may be based on one or more of the ingredients of the personal care product. For example, an ingredient may cause a personal care product to be more white or less white, to be more sticky or less sticky, to have a certain taste and/or smell, to cause more of a burning sensation or less of a burning sensation, to provide additional shadings or less shadings of tooth whitening, etc. The value of property 212b may be affected by one or more ingredients of the personal care product.

As described herein, a composition (e.g., chemical composition) may form a product, such as a personal care product, foodstuff, pharmaceutical, and the like. The chemical composition may be comprised of one or more ingredients (e.g., ingredient data), such as ingredients 222, 232.

FIG. 2B is an example table of data relating to a composition. The composition may be a chemical composition that forms a product, such as a personal care product, foodstuff, pharmaceutical, and the like. As described herein, examples of personal care products may include oral care products (e.g., a toothpaste, mouthwash, etc.), hair products (e.g., a shampoo, hair gel, etc.), skin products (e.g., moisturizers, soaps, etc.), etc. A personal care product may include ingredients, such as the example ingredients named under column 282. For example, the chemical composition forming the personal care product may include ingredients such as sorbitol, water, glycol, etc.

The ingredients (e.g., each of the ingredients) may be identified in one or more ways. For example, the ingredients may be identified by name. The ingredients may be identified by their chemoinformatic properties. Also, or alternatively, the ingredients may be identified by an identification number (e.g., a unique identification number), such as by the identification numbers provided under column 280. The identification number may be used by a user and/or one or more software applications to identify the ingredient. The identification number may be used to conceal the true identity of the ingredients, for example, in instances when the identification of the ingredients is confidential. The identification numbers may be randomly generated, may be generated and/or listed in an order (such as an increasing or decreasing order), etc. Although the table of FIG. 2B shows the identifications under column 280 as alphanumeric characters, it will be understood by those of skill in the art that the identifications may be represented as any combination of numbers, letters, special characters, etc.

FIG. 2B further provides values, such as the percentage values shown in column 284. The percentage values may relate to the percentage in which the ingredient comprises the chemical composition forming the personal care product. For example, as shown in FIG. 2B the ingredient demineralized water comprises 18.296 percent of the chemical composition, Sodium Lauryl Sulfate powder comprises 1.5 percent of the chemical composition, and sodium saccharin USP or EP comprises .3 percent of the chemical composition.

FIG. 2C shows a depiction of other example data that may be associated with a composition. The composition may form a variety of products, such as a personal care product 200, a foodstuff, a pharmaceutical, etc. Like numbers may refer to like elements.

As described herein, data associated with a product, such as personal care product 200, may include an identity (such as a name of the personal care product), ingredients of the personal care product, chemoinformatic values of ingredients of personal care product, clinical trial and/or clinical outcome information of the personal care product, user-related information (e.g., demographic information) of the personal care product, formulation attributes of the personal care product, or one or more other identifiers used to identify the personal care product.

Personal care product 200 may be associated with a unique number 212a that may be referenced by a user and/or computer when referring to the personal care product. Each personal care product 200 may have one or more other values and/or properties, such as one or more properties 212b. Property 212b may be a chemical property associated with the chemical composition of the personal care product, a sensory attribute associated with the personal care product, a non-sensory attribute associated with the personal care product, and the like. As an example, property 212b may include sensory attributes including a color, shape, size, taste, smell, etc., of the product and/or the packaging of the product. Also, or alternatively, property 212b may include text associated with the product, such as the content of the text (e.g., what the text actually says), the font of the text, the size of the text, the color of the text, and the like. Property 212b may be one or more ingredients of which the product is derived.

One or more properties 212b may correspond to one or more financial values relating to a product, such as profitability 290 of the product, market share 292 of the product, market value 294 of the product, growth percentage of the product, and the like. The profitability, market share, growth percentage, and/or market value of the product may be based on a particular region (e.g., country) in an example, although in other examples the profitability, market share, and/or market value of the product may be based on more than one region or a combination of regions. For example, personal care product 200 may have the property 212b that is the color red. The red product may have a profitability 290 of 200%, a market share 292 of 12%, and a market value 294 of $3.10. In other examples, personal care 200 may have a value of the property 212b being the color yellow. The yellow product may have a profitability 290 of 105%, a market share 292 of 3%, and a market value 294 of $0.70. In still other examples, personal care 200 may have a value of the property 212b being the ingredient pineapple. The product having the pineapple may have a profitability 290 of 250%, a market share 292 of 18%, and a market value 294 of $4.10.

FIG. 2D provides values relating to the product, such as the unique identifier 296 of the product, the property 212b of the product, the profitability 290 of the product, the market share 292 of the product, and the market value 294 of the product. Profitability 290 of the product may be how profitable the product is, such as the amount of revenue the product has generated related to the costs to produce the product. Market share 292 of the product may be the percentage of the market that is accounted for by the product. Market value 294 of the product may be the price that consumers are expected to pay to purchase the product.

As shown on FIG. 2D, property 212b may include different colors of the product, packaging of the product, and text provided on the product and/or packaging. Property 212b may include ingredients in which the product is derived, shapes of the product, and flavors of the product. It should be understood, however, that the attributes provided in FIG. 2D are for illustration purposes only and are not intended to be limiting. For example, other properties 212b may relate to the product, such as smell of a product, a consistency of a product, etc.

As described herein, products (e.g., personal care products) may be formed of (e.g., formulated using) one or more chemical compositions comprising one or more ingredients. Formulating personal care products using more than one chemical composition and/or one or more ingredients may present a number of challenges. For example, combining chemical compositions may cause values of properties of the chemical composition forming the personal care product to change. As an example, combining two or more ingredients in a chemical composition may cause the pH value to change. The pH value may be changed in an unpredictable way, for example, based on the interaction of the two or more ingredients.

As adding, removing, and/or mixing ingredients within a chemical composition may affect values of properties of the chemical composition, it may be difficult to create personal care products in which the addition, reduction, or mixing of ingredients is required. For example, personal care products may be required to be pharmaceutically and/or cosmetically acceptable for their intended uses and/or purposes. The intended uses and/or purposes may be based on a value of a property (e.g., pH) of the chemical composition. By combining new ingredients to a chemical composition, or removing ingredients from a chemical composition, a value of the property (e.g., a value of pH) of the chemical composition may change such that the chemical composition forming the personal care product is no longer suitable for the personal care products intended purposes.

Chemical compositions forming personal care products may contain therapeutic active materials that may (e.g., may only) deliver desired results if the compositions have not exhibited a chemical degradation. By combining new ingredients to a chemical composition, or removing ingredients from a chemical composition, a value of the property of the chemical composition may change such that the chemical composition forming the personal care product incurs a chemical degradation. Such a chemical degradation may cause the personal care product to no longer be suitable for consumer use.

Chemical compositions forming personal care products may contain cosmetically functional materials that may (e.g., may only) deliver the material to the oral cavity, skin, and/or hair, etc. at effective levels under the conditions that they are typically used by the consumer. By combining new ingredients to a chemical composition, or removing ingredients from a chemical composition, a value of the property of the chemical composition may change such that the chemical composition forming the personal care product no longer performs at the required effective levels.

Chemical compositions forming personal care products may (e.g., may only) exhibit an aesthetic appearance for a time period. Such aesthetic appeal of chemical compositions may be important, for example, as such aesthetic appeal may have significant effects on consumer acceptance and usage. By combining new ingredients to a chemical composition, or removing ingredients from a chemical composition, a value of the property of the chemical composition may change such that the chemical composition forming the personal care product is no longer aesthetically pleasing.

Chemical compositions forming personal care products may exhibit one or more attributes that are perceived by a consumer. For example, chemical compositions forming a personal care product may exhibit a flavor, sweetness, case of use, etc., as perceived by a consumer. By combining new ingredients to a chemical composition, or removing ingredients from a chemical composition, a value of the property of the chemical composition may change such that the chemical composition forming the personal care product affects the consumer perception of the personal care product. For example, the value of the property of the chemical composition may be affected such that the personal care product exhibits a more minty flavor, a more salty taste, etc.

Chemical compositions forming foodstuffs may exhibit one or more attributes that are perceived by a consumer. For example, chemical compositions forming foodstuffs may exhibit a flavor, sweetness, etc., as perceived by a consumer. Chemical compositions forming foodstuffs may provide weight management, medical benefits, etc. By combining new ingredients to a chemical composition, or removing ingredients from a chemical composition, a value of the property of the chemical composition may change such that the chemical composition forming the personal care product affects the weight loss of a user of the foodstuff. For example, the value of the property of the chemical composition may be affected such that the foodstuff results in additional weight loss or health benefits to a user.

In addition to the affects that adding or removing ingredients has to the composition of the product, one or more features relating to the product may affect one or more other attributes of the product, as described herein. For example, sensory and/or non-sensory features relating to the product may affect one or more attributes of the product, such as profitability of the product, market share of the product, market value of the product, growth potential of the product, price indices of the product, regions in which the product is popular or unpopular, and the like. As an example, a color of the product and/or packaging of the product may determine the profitability of the product, ingredients (e.g., pineapple) of which the product is made may determine the market value of the product, a taste (e.g., minty) of the product may determine the market share of the product, etc.

As described herein, it may be possible to determine a value of a property of a product. For example, it may be possible to determine the value of a property of a chemical composition forming a product, such as a personal care product. A value of a property of a personal care product composition may be experimentally measured, mathematically calculated, and/or received via clinical and/or consumer trials. As another example, it may be possible to determine one or more features of the product that may relate to the profitability, market share, market value, etc., of the product. However, such techniques may be time consuming, nontrivial, and/or impossible, as the personal care product composition and/or features relating to the product may include dozens (or more) of ingredients and/or other features. Machine learning techniques may be used to determine one or more values of properties of a product, as described herein.

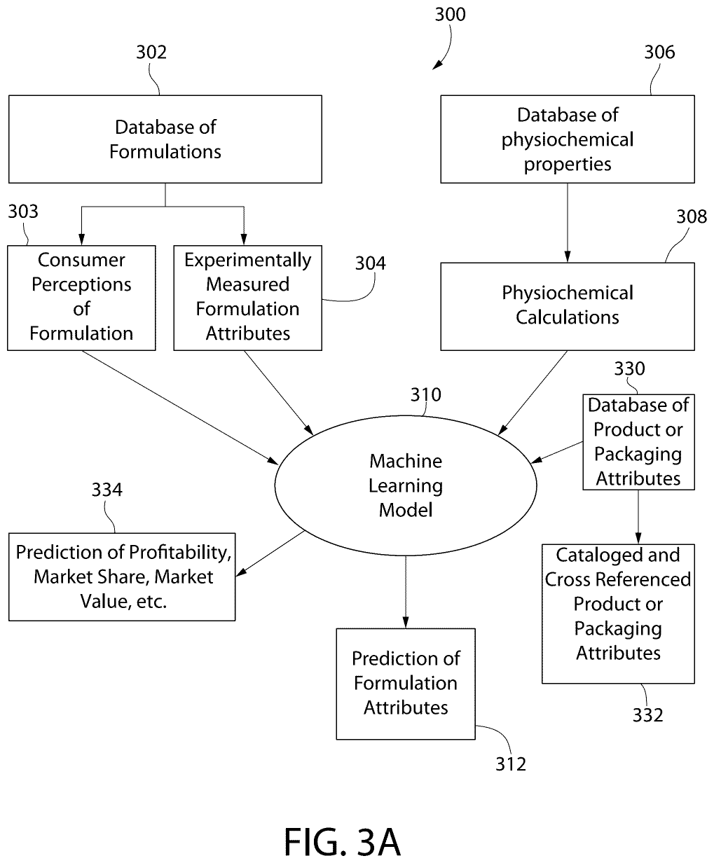

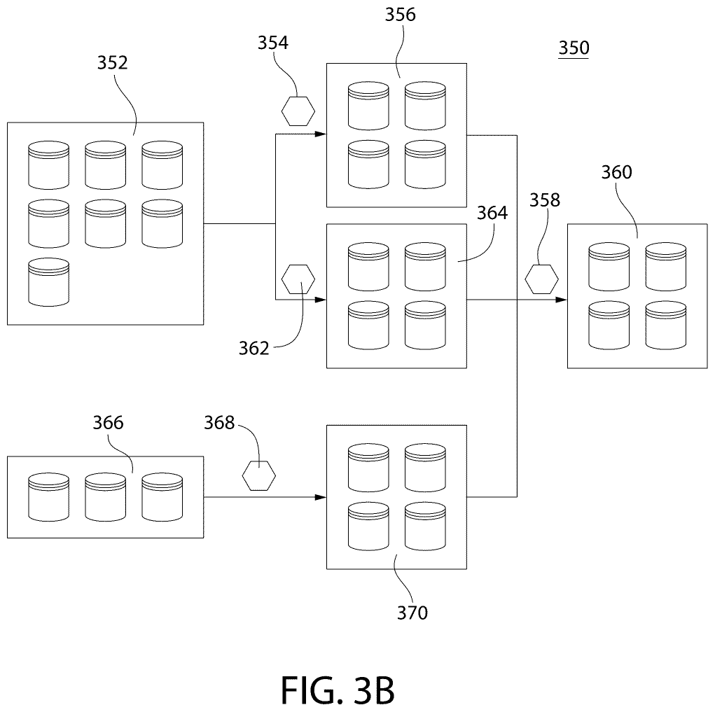

FIG. 3A shows an example process 300 for using machine learning techniques to determine (e.g., predict) an attribute. The attribute may include an identity of a composition, ingredients of a composition, a value of a property of a composition, a feature relating to the property of the composition, profitability of the product (e.g., the product made of the composition), market share of the product, market value of the product, growth potential of the product, price indices of the product, etc. The attribute may include an identity of a chemical composition forming a personal care product, ingredients of a chemical composition forming a personal care product, a value of a property (e.g., a pH value, a fluoride stability value, a viscosity value, an abrasion value, a specific gravity value, a consumer perception value) of a chemical composition forming a personal care product, a feature (e.g., period of time, user-related information, environmental factors) relating to the property, etc. Although the disclosure may describe the determination (e.g., prediction) of an attribute of a chemical composition forming a personal care product, it should be understood that machine learning techniques may also, or alternatively, be used to determine (e.g., predict) one or more attributes, such as other identities of products, values of chemoinformatic properties of ingredients of products, features relating to properties, etc. It should also be understood that machine learning techniques for determining chemical values is for illustration purposes only and machine learning techniques may also, or alternatively, be used to determine one or more values of non-chemical compositions.

At 302, one or more identities of chemical compositions (e.g., sample chemical compositions of a personal care product) may be stored, for example, in a database. The identity of the chemical composition may include a name of a chemical composition, ingredients of the chemical composition (e.g., formulations of the chemical composition), etc. For example, as shown in FIG. 2A, the identity of the chemical composition may include chemoinformatic properties (e.g., chemoinformatic values) of each of the ingredients of the chemical composition. The identity of a chemical composition may be received from one or more of the databases.

At 303, one or more perceptions of chemical compositions forming one or more products (e.g., personal care products) may be determined and/or received. The perceptions of the chemical compositions may be determined and/or identified via clinical trials and/or consumers (e.g., potential consumers). The perceptions may include the whiteness of the personal care product, how minty the personal care product is, the sweetness of the personal care product, etc. The perceptions of the chemical compositions may be affected by one or more ingredients of the chemical composition forming the personal care product. For example, one or more ingredients may affect how minty a consumer perceives the personal care product to be, how sweet the consumer perceives the personal are product to be, how white the consumer perceives the personal are product to be, etc.

At 304, values of properties of chemical compositions forming one or more products (e.g., personal care products) may be determined. For example, values of properties of chemical compositions forming one or more products may be determined via experimental measurements, clinical and/or consumer trials, etc. The values of the properties may be affected by one or more ingredients of the chemical composition. The values of the properties may be affected by one or more features related to the property, such as a period of time at which the property was measured, user-related information of consumers of the chemical composition, environmental factors of the chemical composition, packaging of the chemical composition, etc. The experimentally measured values of properties of the chemical composition may be identified by performing actual measurements of the values of the properties of the chemical compositions. The experimentally measured values of properties of the chemical composition may be identified by retrieving the experimentally measured values of the properties from a database, for example, after the experimentally measured values of the properties have been stored in a database. The experimentally measured values of properties of the chemical composition (e.g., sample chemical compositions) may be received.

At 306, one or more values of a chemical composition forming a personal care product may be determined and/or stored, for example, in a database. The one or more values of the chemical composition may relate to physiochemical properties of a chemical composition. The value of a physiochemical property may include a value for one or more (e.g., each) ingredients of the chemical composition. The value of a physiochemical property may be received, for example, from one or more databases.

At 308, the values of physiochemical properties of the chemical composition may be identified and/or determined. The values of physiochemical properties of the chemical composition may be determined by measuring the physiochemical properties of the ingredients of the chemical composition, calculating (e.g., mathematically calculating) predicted values of the physiochemical properties of the chemical compositions, looking up the values of the physiochemical properties (e.g., via a database, look-up table, etc.), etc. The values of physiochemical properties of the chemical composition may be identified and/or determined via thermodynamic calculations of the physiochemical properties.

At 330, one or more values of a product (e.g., personal care product) and/or packaging of the product may be determined and/or stored, for example, in a database. The one or more values of the product may relate to sensory attributes, such as colors of the product and/or packaging, taste of the product, smell of the product, feel of the product, etc. The one or more values of the product may relate to the advertising and/or marketing of the product, such as the text (e.g., content, size, font, color of the text) on a label of the product. For example, the one or more values may relate to the word “charcoal” on the label in which the text is displayed in bold font. The values of the product may be received, for example, from one or more databases. At 332, the values of the product may be cataloged and/or cross-referenced. For example, correlations between the values of the product and profitability, market share, market value, and the like may be performed.

At 310, data may be input into a machine learning model, as described herein. For example, identities of chemical compositions may be input into the model. Identities of chemical compositions may include names of one or more of the chemical compositions, identities of ingredients of the chemical compositions, values of chemoinformatic properties (of ingredients) of the chemical compositions, etc. Values of properties of the chemical composition may be input into the machine learning model. For example, values of properties (e.g., experimentally measured values, mathematically calculated values, consumer perceived values) of the chemical composition may be input into the model. Features related to the values of properties of the chemical composition may be input into the machine learning model. For example, periods of time, user-related information, and environmental factors of the chemical compositions may be input into the model. Data related to chemical compositions may be input into the model to train the model, in examples. In other examples, data related to a product may be input into the model to determine values (e.g., other values) of the product, such ingredients of a product, sensory attributes of the product, non-sensory attributes of the product, and the like.

An association may be input into the model. For example, there may be an association between an identity (e.g., ingredients) of a chemical composition, a value of a property of the chemical composition (e.g., chemical composition forming a product), a feature relating to the value of the property of the chemical composition, sensory attributes relating to a product, non-sensory attributes of the product, financial characteristics of the product, and the like. The association between features relating to the value of the property, and the value of the property, may be input into the model separately and/or in conjunction with other associations. The ingredients of a chemical composition (e.g., a sample chemical composition), the associated value of the property of the chemical composition (e.g., a sample chemical composition), and/or the feature relating to the value of the property of the chemical composition may be input into a machine learning model, for example, to train the machine learning model.

At 312, the machine learning model may determine (e.g., predict) a value of one or more pieces of data relating to the chemical composition. For example, if an identity of a chemical composition (e.g., a considered chemical composition) is input into the machine learning model, the machine learning model may determine (e.g., predict) a value of a property of the chemical composition based on the identity of the chemical composition. Conversely, if a value of a property of a chemical composition (e.g., considered chemical composition) is input into the machine learning model, the machine learning model may determine (e.g., predict) an identity of the chemical composition based on the value of the property of the chemical composition.

At 334, the machine learning model may determine (e.g., predict) a value of one or more pieces of data relating to the product. As an example, if an attribute (e.g., color) of a product is input into the machine learning model, the machine learning model may determine (e.g., predict) a value of a property (e.g., value of a profitability, market share, market value, etc.) of the product based on the color. As another example, if an ingredient of a product and text of a label is input into the machine learning model, the machine learning model may determine (e.g., predict) a value of a property (e.g., value of a profitability, market share, market value, etc.) of the product based on the color. Conversely, if a value of a property (e.g., value of a profitability, market share, market value, etc.) of a product is input into the machine learning model, the machine learning model may determine (e.g., predict) an attribute (e.g., color, shape, taste, ingredient, text) of the product based on the value of the property of the product.

In other examples, if an identity of a chemical composition (e.g., a considered chemical composition) and a feature relating to the property is input into the machine learning model, the machine learning model may determine (e.g., predict) a value of a property of the chemical composition based on the identity of the chemical composition and the feature related to the property. Conversely, if a value of a property of a chemical composition (e.g., considered chemical composition) is input into the machine learning model, the machine learning model may determine (e.g., predict) an identity of the chemical composition and a feature related to the property based on the value of the property of the chemical composition. Although the above provides examples of machine learning attributes, it should be understood that these examples are for illustration purposes only and are non-limiting. One or more different permutations of values may be input into the machine learning model and/or output from the machine learning model.

FIG. 3B is an example diagram of system 350 for determining information relating to a composition, such as a chemical composition forming a product (e.g., a personal care product). The information may relate to an identity of a chemical composition, chemoinformatic values of the chemical composition, as well as one or more other values relating to a product. System 350 may be a data warehouse, in an example. For example, system 350 may include one or more databases for receiving, storing, and/or providing data and/or one or more processors for processing the data received, stored, and/or provided by one or more of the databases.

System 350 may include element 352, which may include one or more databases. For example, element 352 may include one or more databases receiving, storing, and/or providing formulation identifiers, raw materials in one or more (e.g., each) of the formulations, and/or weight percentages of one or more (e.g., each) of the raw materials in a formulation. Element 352 may include one or more databases receiving, storing, and/or providing formulation identifiers, descriptive sales, and/or logistical information. Element 352 may include one or more databases receiving, storing, and/or providing raw material identifiers, cost(s), manufacturer information, and/or logistical information. Element 352 may include one or more databases receiving, storing, and/or providing raw material identifiers, chemicals in one or more (e.g., each) raw material, and/or weight percentages of one or more (e.g., each) chemical in a raw material. Element 352 may include one or more databases receiving, storing, and/or providing raw material identifiers and/or informatic (e.g., chemoinformatic) properties of the raw materials. Element 352 may include one or more databases receiving, storing, and/or providing chemical identifiers and/or informatic (e.g., chemoinformatic) properties of the chemicals. Element 352 may include one or more databases receiving, storing, and/or providing thermodynamic and kinetic reaction constants between chemicals, such as all known thermodynamic and kinetic reaction constants between all chemicals.

At 354, feature selection, representation, and/or engineering may be performed. For example, rules (e.g., algorithms) may perform feature selection, representation, and/or engineering.

System 350 may include element 356, which may include one or more databases. For example, element 356 may include one or more databases receiving, storing, and/or providing formulation identifiers, select features in a (e.g., each) formulation (such as a combination of identifiers, material informatics, chemical informatics, etc.), and/or representation (e.g., quantitative representation) of the abundance of a feature in a formulation.

At 362, chemical speciation calculations (e.g., based on thermodynamic and/or kinetic constants) may be performed. For example, rules (e.g., algorithms) may perform chemical speciation calculations (e.g., based on thermodynamic and/or kinetic constants).

System 350 may include element 364, which may include one or more databases. For example, element 364 may include one or more databases receiving, storing, and/or providing formulation identifiers, calculated values of a property of a chemical composition, and/or equilibrium properties (e.g., based on kinetics and thermodynamic constants).

System 350 may include element 366, which may include one or more databases. For example, element 366 may include one or more databases receiving, storing, and/or providing formulation identifiers and/or testing values (e.g., experimentally determined analytical testing values of a property of a chemical composition). The property of the sample chemical composition may be affected by an interaction two or more of the ingredients of the sample chemical composition. Element 366 may include one or more databases receiving, storing, and/or providing formulation identifiers and/or consumer-derived testing results. Element 366 may include one or more databases receiving, storing, and/or providing formulation identifiers and/or clinical testing results.

At 368, fitting parameters of testing results may be determined. For example, rules (e.g., algorithms) may determine fitting parameters of testing results.

System 350 may include element 370, which may include one or more databases. For example, element 370 may include one or more databases receiving, storing, and/or providing formulation identifiers, aggregated testing results, and/or fitting parameters associated with testing results.

At 358, machine learning information may be determined. For example, rules (e.g., algorithms) may determine machine learning information.

System 350 may include element 360, which may include one or more databases. For example, element 360 may include one or more databases receiving, storing, and/or providing machine learning model parameters. In one or more aspects, the algorithms may include at least a Monte Carlo algorithm, among other algorithms, for example. The Monte Carlo algorithm is a randomized algorithm whose output may be incorrect, perhaps for example with some small probability. Monte Carlo algorithms may include the Karger-Stein algorithm, among other algorithms, for example.

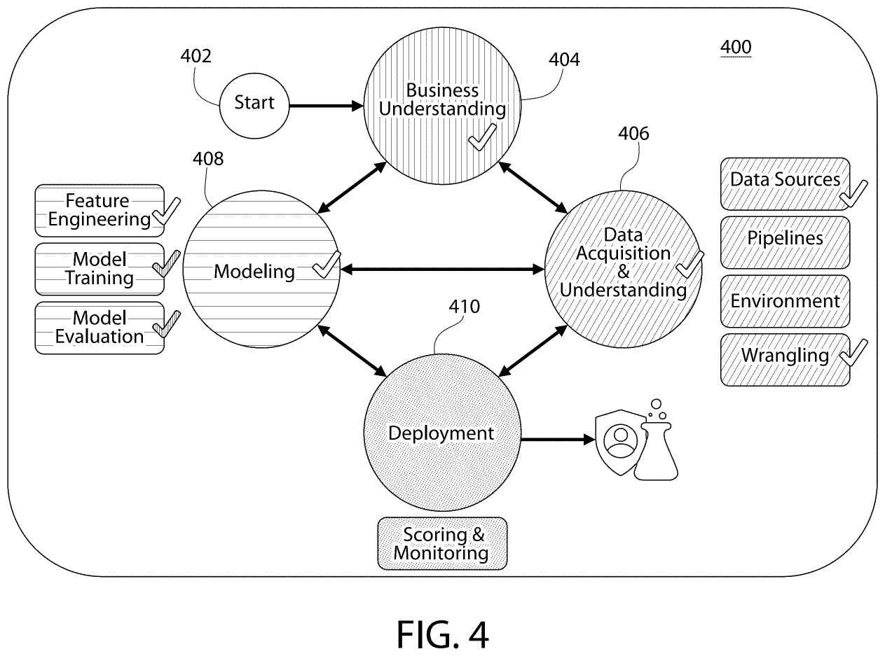

FIG. 4 is a process 400 showing other example steps of predicting chemical composition information via machine learning rules, as described herein. Hatch lines are used in FIG. 4 to denote relationships within the process.

At 402, the process begins. At 404, an entity (e.g., a business) may begin to understand and/or improve its understanding of chemical composition information. For example, the entity may begin and/or improve its understanding of a need for chemical compositions to have a feature, such as a chemical composition having a pH of a certain value, an emulsifying purpose, a sweetness, a thickener, etc. Although the entity may understand a need for the chemical composition to have a certain property (e.g., property value), the entity may not know the ingredients of the chemical composition that will create such a property (e.g., property value).

At 406, data relating to the chemical composition may be acquired. For example, the entity may acquire identities (e.g., names, ingredients, chemoinformatic properties, etc.) of chemical compositions, values of properties of chemical compositions, features related to values of properties of chemical compositions, etc. The information of the chemical composition may be acquired via an experimental measurement, a mathematical computation, clinical and/or consumer trials, one or more data sources (e.g., a database, file, etc.), or other informational avenues. An association between the information may be identified and/or determined. For example, an association between an identity of a chemical composition and a value of a property of the chemical composition may be determined, an association between a feature related to a value of a property of a chemical composition and the value of the property of the chemical composition may be determined, etc.

At 408, a machine learning model may be trained and/or used, as described herein. For example, information relating to a chemical composition (e.g., a sample chemical composition) forming a product may be used to train a machine learning model. The information may be an identity of a chemical composition and an associated value of a property of the chemical composition. The information may be an identity of a chemical composition, an associated value of a property of the chemical composition, and/or a feature related to the value of the property. The information may be sensory and/or non-sensory attributes of a product (e.g., product made of the chemical composition). The trained machine learning model may be used to determine and/or predict a value (e.g., an unknown value) of a chemical composition (such as a considered chemical composition). For example, a value may be predicted based on an identity of the chemical composition (e.g., the chemical composition), an attribute of the product, and/or a feature related to a value of a property.

At 410, the machine learning model may be deployed. At deployment, the machine learning model may determine a value of a property of a chemical composition (e.g., a considered chemical composition) based on an identity of the chemical composition and/or a feature related to the value of the property. The machine learning model may determine a profitability, market share, market value, and the like, of the product based on an attribute of the product, or vice-versa. The machine learning model may determine an identity of the chemical composition based on a value of a property of a chemical composition and/or a feature related to the value of the property, etc.

The determined value of the property of the chemical composition may be compared against a desired value of the property of the chemical composition. For example, the pH value returned from the machine learning model may be compared against a desired pH value. The pH value returned from the machine learning model may be compared against an actual (e.g., actually measured) pH value. If it is determined that the value of the property is the same (e.g., substantially the same) as the desired value, the entity may move towards creating a chemical composition (e.g., a personal care product) having the desired value of the property. The entity may use the ingredients input into the machine learning model to create the chemical composition having the desired value of the property. For example, the entity may create a chemical composition using the ingredients input into the machine learning model that resulted in a determined (e.g., predicted) pH value that is desired. A product (e.g., personal care product) may be created using the chemical composition such that the product (e.g., personal care product) will be comprised of ingredients resulting in the desired value of the property.

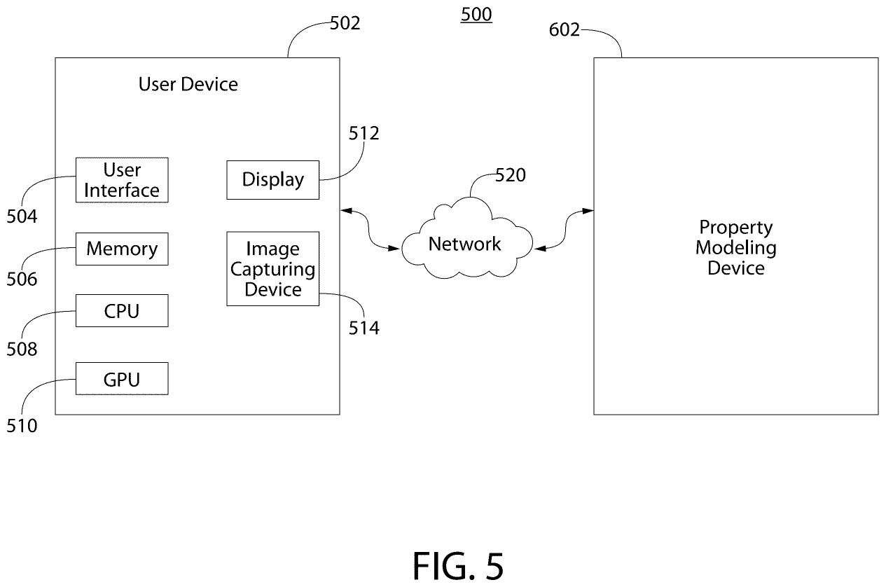

FIG. 5 is a block diagram of an example system 500 for determining (e.g., predicting) data associated with a product, such as the composition (e.g., chemical composition) forming the product (e.g., personal care product), profitability of the product, market share/value of the product, etc. Data may include an identity of a product (e.g., chemical composition forming the product), a value of a property of a product, a feature related to the property of the product, and/or one or more other types of data, such as a sensory and/or non-sensory attributes of the product.

The data may be determined based on one or more attributes and/or parameters. For example, system 500 may determine (e.g., predict) the data associated with a property of a product (e.g., chemical composition) based on one or more attributes/parameters and machine learning techniques. Although examples provided herein may relate to determining (e.g., predicting) an identity of a product (e.g., a chemical composition forming a product), a value of a property of a product, a feature relating to the property of a product, and/or a fitting parameter using machine learning techniques, a person of skill in the art will understand that one or more other values and/or parameters relating to a product may be determined (e.g., predicted) using machine learning techniques. For example, chemoinformatic values of ingredients of a chemical composition may be determined, chemical constants may be determined, clinical and/or consumer outcomes and perceptions may be determined, sensory and/or non-sensory attributes may be determined, profitability may be determined, market share/value may be determined, etc.

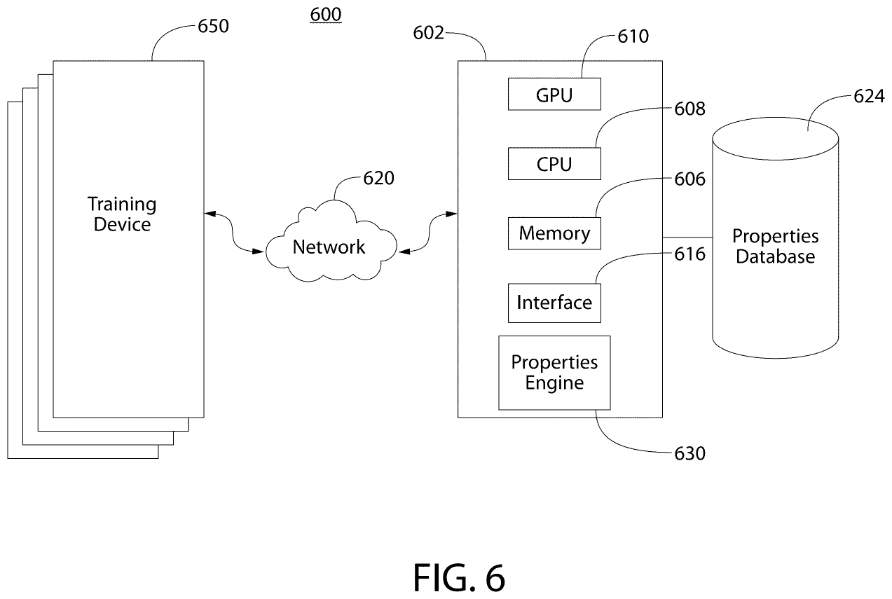

System 500 includes a user device 502 configured to connect to a properties modeling device, such as example properties modeling device 602 (further described in FIG. 6) via a network 520. Network 520 may include wired and/or wireless communication networks. For example, networks 520 may include a local area network (LAN), a metropolitan area network (MAN), and/or a wide area network (WAN). Network 520 may facilitate a connection to the Internet. In further examples, network 520 may include wired telephone and cable hardware, satellite, cellular phone communication networks, etc.

User device 502 may include a user interface 504, a memory 506, a central processing unit (CPU) 508, a graphics processing unit (GPU) 510, an image capturing device 514, and/or a display 512. User device 502 may be implemented as a user equipment (UE) such as a mobile device, a computer, laptop, tablet, desktop, or any other suitable type of computing device.

User interface 504 may allow a user to interact with user device 502. For example, user interface 504 may include a user-input device such as an interactive portion of display 512 (e.g., a “soft” keyboard displayed on display 512), an external hardware keyboard configured to communicate with user device 504 via a wired or a wireless connection (e.g., a Bluetooth keyboard), an external mouse, or any other user-input device. The user interface 504 may allow a user to input, view, etc. one or more pieces of information relating to a chemical composition forming a personal care product.

Memory 506 may store instructions executable on the CPU 508 and/or the GPU 510. The instructions may include machine readable instructions that, when executed by CPU 508 and/or GPU 510, cause the CPU 508 and/or GPU 510 to perform various acts. Memory 506 may store instructions that when executed by CPU 508 and/or GPU 510 cause CPU 508 and/or GPU 510 to enable user interface 504 to interact with a user. For example, executable instructions may enable user interface to display (via Display 512) one or more prompts to a user, and/or accept user input. Instructions stored in memory 506 may enable a user to input an identity of a chemical composition and/or a value of a property of the chemical composition, for example. In other examples, a user may utilize user interface 504 to click, hold, or drag a cursor to define identities, values, and/or properties of a chemical composition.

CPU 508 and/or GPU 510 may be configured to communicate with memory 506 to store to and read data from memory 506. For example, memory 506 may be a computer-readable non-transitory storage device that may include any combination of volatile (e.g., random access memory (RAM)) or non-volatile (e.g., battery-backed RAM, FLASH, etc.) memory.

Image capturing device 514 may be configured to capture an image. The image may be a two-dimensional image, a three-dimensional image, etc. Image capturing device 514 may be configured to capture an image in a digital format having a number of pixels. Although image capturing device 514 is illustrated in FIG. 5 as internal to user device 502, in other examples image capturing device 514 may be internal and/or external to user device 502. In an example, image capturing device 514 may be implemented as a camera coupled to user device 502. Image capturing device 514 may be implemented as a webcam coupled to user device 502 and configured to communicate with user device 502. Image capturing device 514 may be implemented as a digital camera configured to transfer digital images to user device 502 and/or to properties modeling device 602. Such transfers may occur via a cable, a wireless transmission, network 520/620, and/or a physical memory card device transfer (e.g., SD Card, Flash card, etc.), for example. Image capturing device 514 may be used to capture an image of a personal care product, a chemical composition forming the personal care product, data relating to the chemical composition, data relating to one or more features of a personal care product, etc.

In examples the user may input information into the user device 502 relating to one or more compositions (e.g., chemical compositions). The chemical composition information may be transferred to and/or from the properties modeling device 602, as shown in FIG. 5. With the properties modeling device 602 having information relating to the chemical compositions (e.g., the identities of the chemical compositions and/or the values of the properties of the chemical compositions), the properties modeling device 602 may return information about the chemical composition. For example, the properties modeling device 602 may provide values (e.g., predicted values) of properties of chemical compositions, products, etc.

User device 502 may obtain information (e.g., unknown information) about one or more products (e.g., names of chemical compositions forming products, ingredients of chemical compositions, chemoinformatic values of ingredients of chemical compositions, values of properties of chemical compositions, features related to properties of chemical compositions, attributes (e.g., sensory and/or non-sensory attributes of products), profitability of products, market share/value of products, etc.) for prediction purposes. For example, a user (e.g., a user of user device 502) may desire to know an identity of a chemical composition having a value (e.g., desired value) of a property of a personal care product. The value of the property may be affected by one or more ingredients of the chemical composition interacting within one another. The value (e.g., desired value) of a property of a personal care product may be a value (e.g., a pH value) of the personal care product, a function of one or more ingredients of the personal care product, a classification of one or more ingredients of the personal care product, a consumer perception of the personal care product, etc.

The user may input one or more types and/or values of product and/or chemical composition information (e.g., names, ingredients, chemoinformatic properties, sensory attributes, non-sensory attributes, etc.) into the user device 502, for example, to determine information (e.g., other information) about the chemical compositions. The user device 502 may transmit the information to a modeling device, such as properties modeling device 602.

In examples all or some of the steps, processes, methods, etc., may be performed by one device or more than one device (e.g., user device or chemical property modeling device). For example, user device 502 may include properties engine 630 in examples. In other examples, properties modeling device 602 may be external to user device 502. In examples in which properties modeling device 602 is separate from user device 502, user device 502 may communicate with properties modeling device 602 via one or more wired and/or wireless techniques, as described herein. For example, as shown in FIG. 5, user device 502 may communicate with chemical property modeling device 502 via network 520. Network 520 may be the Internet, in some examples. In other examples, as described herein, network 520 may be Wi-Fi, Bluetooth, LAN, etc.

A value of a property (e.g., a desired value of a property) of a product (e.g., chemical composition forming a product) may be received. The product in which the value of the property is received and in which the identity of the product is to be determined by machine learning rules may be referred to as a considered and/or a potential product. For example, a user may receive a value (e.g., a desired value) of a property of a product (e.g., a chemical composition forming a product). The user may transfer the value of the property to the properties modeling device 602. The value may relate to a property that is affected by one or more attributes of the product, such as ingredients of the product. The value may relate to a pH value, a fluoride stability value, a viscosity value, an abrasion value, a specific gravity value, a clinical trial and/or clinical outcome value, a user-specific information (e.g., demographics information) value, a period of time value, storage information (e.g., storage temperature, storage humidity), a biomarker value, a consumer perception value, sensory and/or non-sensory attributes of the product, profitability of the product, market value/share of the product, etc.

A user may transfer a pH value to the properties modeling device 602, a stability value to the properties modeling device 602, a clinical trial and/or clinical outcome value to the properties modeling device 602, a user-specific value (e.g., demographic information) to the properties modeling device 602, a biomarker value to the properties modeling device 602, a color to the properties modeling device 602, text of a label to the properties modeling device 602, a profitability to the properties modeling device 602, a market share/value to the properties modeling device 602, etc.

A user may transfer one or more values of one or more properties to the properties modeling device 602. A user may transfer one or more features that relate to one or more properties to the properties modeling device 602. The value of the property and the feature that relates to the property may be transferred to the properties modeling device 602, for example, at the same time or at different times. An indication of the relationship between the value of the property and the feature that relates to the property may be transferred to the properties modeling device 602.

A value of a property may correspond to clinical trial and/or clinical outcome data, consumer trial and/or consumer outcome data, etc. The value of the property corresponding to the clinical trial and/or clinical outcome data may be a consumer perceived liking of a product (e.g., fragrance), a clinical whitening efficacy of a toothpaste, a hydrating ability of a skin cream, etc. As described herein, the identity of the chemical composition (e.g., the ingredients and/or chemoinformatic properties of the chemical composition) may be transferred to the properties modeling device 602, corresponding property values (such as clinical trial and/or clinical outcome data) may be transferred to the properties modeling device 602, and/or one or more additional datasets may be transferred to the properties modeling device 602. The additional datasets may be data that relates to the property data, such as the clinical trial and/or clinical outcome data.

A value of the property may correspond to a sensory attribute of the product and/or packaging housing the product. For example, a value of the property may correspond to a color of the product and/or packaging, a shape of the product and/or packaging, a taste of the product and/or packaging, a smell of the product and/or packaging, etc. A value of the property may correspond to a non-sensory attribute, such as text displayed on the product and/or packaging. For example, one or more groupings of words presented on the packaging of the product may correspond to one or more success indicators of the product. As an example, a label reciting the phrase “tooth whitening” may correlate with a product being profitable and/or achieving a high market share/value. As another example, a label reciting the phrase “bad” may correlate with a product being unprofitable and/or achieving a low market share/value.

A user may transfer an identity of a product (e.g., ingredients of a composition forming the product) and a property (e.g., a tooth whitening) of the product to the properties modeling device 602. The user may transfer a feature relating to the property (e.g., tooth whitening) of the product. The feature relating to the property may be a formulation attribute (e.g., an oxidation potential of the product), a period of time (e.g., the value of the tooth whitening at six weeks of use, eight weeks of use), user-related data (e.g., the age of the consumer using the product, the geographic data related to the consumer, the brushing habits of the user, etc.), the profitability of the product, and the like.

Although the above examples may relate to user-related information and period of time information, other types of information relating to the property may be transferred to the properties modeling device 602, such as information relating to the storage of the product. Other information relating to the property may include information of the user of the product, such as ethnographic information, physical alterations (e.g., tattoos, piercings, etc.), diet, height, weight, body mass index, body hair coverage, bodily sweat production, skin sebum production, biomarkers, hair type/color, skin pH, nutrition, exercise regimen, bodily micro-flora, health/disease conditions, as well as others. Environmental features, such as product storage temperature, product storage humidity, product packaging, variables that impact the kinetics of a chemical reaction occurring in the product or that impacts the kinetics of a phase transformation, etc. may relate to a property and may be transferred to properties modeling device 602.

A user may transfer to properties modeling device 602 an identity of a chemical composition and the value of a property relating to the chemical composition, such as fluoride. The user may also, or alternatively, transfer one or more features relating to the property, such as a time period, environmental information, user-related information, etc. Time periods may include the times of the chemical composition's shelf life, such as the beginning of the chemical composition's shelf life, the end of the chemical composition's shelf life, and/or one or more time periods in between. For example, the user may transfer to properties modeling device 602 an identity of a toothpaste formed of a chemical composition, a value of a fluoride relating to the toothpaste, and a time period of six weeks. Thus, in this example the value of fluoride at six weeks for the particular toothpaste will be transferred to properties modeling device 602.

As another example, user may transfer the value of the property fluoride decay rate. The user may transfer an identity of a toothpaste, a value of the property fluoride decay rate, and one or more time periods and/or one or more storage conditions. For example, user may transfer the identity of the toothpaste, the value of the property fluoride decay rate, time periods at the beginning of the product's shelf life and/or at the end of the product's shelf life, and an indication that the chemical composition is stored in a cool temperature having a low humidity. In other examples a user may transfer the value of the property fluoride decay rate and indicate that the chemical composition is stored in a warm temperature having a high humidity.

Environmental features may affect a consumer's perception of a product. For example, a fragrance may have a bloom (e.g., how a consumer perceives the evolution of the fragrance profile). How the consumer perceives the bloom may depend on one or more environmental features, such as ambient conditions, audio conditions, etc. Other properties may be affected by other environmental factors, such as temperature, humidity, altitude, environmental composition (e.g., a presence of volatile components in the local atmosphere), and the like. The property and the features (e.g., environmental features) in which the property depends may be transferred to the properties modeling device 602. For example, when fragrance bloom is designated as the property transferred to properties modeling device 602, information relating to the property (e.g., environmental conditions, such as ambient conditions) may be transferred to properties modeling device 602.

Based on the value of the property and/or the feature relating to the property, the properties modeling device 602 may provide an identity of a product that has (e.g., is predicted to have) that value (e.g., or approximately that value) for the property and/or that feature relating to that property. As an example, the properties modeling device 602 may provide a name of a composition that has (e.g., is predicted to have) the value and/or feature relating to the property, ingredients of a chemical composition that has (e.g., is predicted to have) the value and/or feature relating to the property, chemoinformatic values of ingredients of a chemical composition that has (e.g., is predicted to have) the value and/or feature relating to the property, etc.

As another example, the properties modeling device 602 may determine sensory and/or non-sensory attributes of a product that has (e.g., is predicted to have) a value and/or feature relating to the property relating to a defined profitability, market share, market value, etc. For example, a user may define a toothpaste product having a profitability of a defined amount. Based on the predefined profitability, the properties modeling device 602 may determine the color of the product and/or packaging of the product to be blue, that the product have a blueberry taste, that the packaging of the product include the term “great tasting.” As another example, a user may define a toothpaste product packaging having a color red, the product having a minty taste, and the packaging including the word “whitening.” Based on the predefined sensory and non-sensory attributes of the product, the properties modeling device 602 may determine (e.g., predict) the market value and profitability of the product. In examples, the properties modeling device 602 may determine (e.g., predict) ingredients of a product having defined sensory attributes, non-sensory attributes, profitabilities, market shares/values, etc., and vice-versa.

The user may also, or alternatively, provide information related to the product (e.g., chemical composition forming the product) to determine a value of a property of the product and/or a feature relating to the property. For example, the user may input into the properties modeling device 602 a name of a composition, ingredients of a chemical composition forming the product, chemoinformatic values of ingredients of a chemical composition forming the product, consumer perceptions of the chemical composition forming the product, etc. Based on the name, ingredient, and/or chemoinformatic information, the properties modeling device 602 may determine a value of a property of the product formed of the chemical composition.

The properties modeling device 602 may determine the value of a property of the product corresponding to a feature relating to the property. For example, based on the name, ingredient, and/or chemoinformatic information, the properties modeling device 602 may determine a pH value, a fluoride stability value, a viscosity value, an abrasion value, a specific gravity value, clinical trial and/or clinical outcome information, etc., of the product formed of the chemical composition. Based on the name, ingredient, and/or chemoinformatic information, the properties modeling device 602 may determine a pH value, a fluoride stability value, a viscosity value, an abrasion value, a specific gravity value, clinical trial and/or clinical outcome information, etc., corresponding to a user-related information (e.g., an age of the user), formulation attribute information, packaging information, period of time information (e.g., the value of the property at six weeks), storage information, etc.

FIG. 6 shows an example system 600 of training a properties engine, such as properties engine 630. Properties engine 630 may be housed in properties modeling device 602, although such a configuration is for illustration purposes only. As shown in FIG. 6, training device 650 may communicate with properties modeling device 602. For example, training device 650 may communicate with properties modeling device 602 via network 620. One or more training devices 650 may provide information to the properties modeling device 602, for example, to train the properties engine 630 of properties modeling device 602, as described herein.

Training device 650 may provide information to a modeling device, such as properties modeling device 602. As an example, information provided to properties modeling device 602 may include identities of chemical compositions (e.g., chemical compositions forming a product), values of properties of chemical compositions, and/or values of features related to the properties of the chemical compositions. As another example, information provided to properties modeling device 602 may include sensory and/or non-sensory attributes related to the product. As described herein, sensory attributes may include the color of a product and/or packaging of the product, a smell of the product, a taste of the product, a touch (e.g., consistency) of the product, and the like. Non-sensory attributes may include text found on the product and/or packaging of the product, ingredients forming the product, etc. The text may include one or more (e.g., a grouping of) terms that may describe the taste of the product (e.g., minty), the effectiveness of the product (e.g., 99% effective to reduce plaque), ingredients of the product (e.g., coconut, oatmeal, charcoal), a goal of the product (e.g., tooth whitening), and the like. Information provided to properties modeling device 602 may include attributes related to cost, profitability, market value/share, etc. of the product, as described herein.

Information provided to properties modeling device 602 may include experimentally measured information relating to a chemical composition (e.g., a chemical composition forming a product, such as a personal care product), mathematically calculated information relating to a chemical composition, clinical/consumer trial and/or outcome information, user-related information, physical characteristics of a user, form factor of the chemical composition, packaging of the chemical composition, biomarker information (e.g., biomarker information relating to users and/or potential users of the of the product), the degree and/or ways in which the product interacts with the environment, environmental features of the chemical composition, consumer perception information relating to a chemical composition, etc. The training device 650 may provide values of properties of chemical compositions, such as actual values of properties of chemical compositions and/or mathematically determined values of properties of chemical compositions.

Training device 650 may provide information relating to products (e.g., chemical compositions relating to products) that include identities of chemical compositions (e.g., names of chemical compositions, ingredients of chemical compositions, chemoinformatic values of ingredients of chemical compositions, etc.), names of products, slogans related to products, and the like.

As provided herein, information provided by training device 650 may be based on actual (e.g., actually measured information, such as values of chemical compositions having actually been measured, clinical trial information, etc.) information. In addition, or alternatively, information provided by training device 650 may be based on values of the chemical compositions being determined using mathematical calculations, such as thermodynamic calculations of the chemical compositions to determine values of properties of the chemical compositions. Providing this information (e.g., actual information and/or thermodynamically calculated information) to the properties engine 630 may be used to train the model, using machine learning techniques, as described herein. The chemical composition for which information is used to train the machine learning rules may be referred to as a sample chemical composition.

Properties modeling device 602 may include a CPU 608, memory 606, GPU 610, interface 616, and properties engine 630. Memory 606 may be configured to store instructions executable on the CPU 608 and/or the GPU 610. The instructions may include machine readable instructions that, when executed by CPU 608 and/or GPU 610, cause the CPU 608 and/or GPU 610 to perform various acts. CPU 608 and/or GPU 610 may be configured to communicate with memory 606 to store to and read data from memory 606. For example, memory 606 may be a computer-readable non-transitory storage device that may include any combination of volatile (e.g., random access memory (RAM), or a non-volatile memory (e.g., battery-backed RAM, FLASH, etc.) memory.

Interface 616 may be configured to interface with one or more devices internal or external to properties modeling device 602. For example, interface 616 may be configured to interface with training device 650 and/or properties database 624. Properties database 624 may store information about products (e.g., products formed of chemical compositions), such as names of products, chemical compositions forming products, ingredients of chemical compositions forming products, chemoinformatic values of ingredients of chemical compositions forming products, values of properties of chemical compositions forming products (e.g., pH values, fluoride (e.g., fluoride stability) values, viscosity (e.g., viscosity stability) values, abrasion (e.g., stain removal and dentin abrasion) values, specific gravity values, clinical trial and/or clinical outcome data, consumer perception (e.g., sweetness, stickiness, fragrance) values), values of features relating to the properties of the chemical composition (e.g., user-related information, period of time information, environment information), sensory attributes relating to products, non-sensory attributes relating to products, financial information (e.g., profitability, market share/value, etc.) relating to products, etc.

The information stored within properties database 624 may be used to train the properties engine 630. The information stored within properties database 624 may also, or alternatively, be referenced by properties engine 630 for determining (e.g., predicting) information about a product and/or chemical composition forming a product (e.g., a considered chemical composition forming a product).

A device (e.g., user device 502 and/or properties modeling device 602) may receive information of one or more products and/or compositions (e.g., chemical compositions) via training device 650 and/or another device. The information may relate to one or more (e.g., many) different types of products and/or compositions, such as chemical compositions, a family of products and/or chemical compositions, complete and/or incomplete chemical compositions, products and/or chemical compositions with extensive history, relatively unknown chemical compositions, compositions that are not chemical in nature, etc.

One or more types of information of a product and/or composition (e.g., chemical composition) may be provided to properties modeling device 602. For example, one or more types of information of a product and/or chemical composition (e.g., sample chemical composition) may be provided to properties modeling device 602 to train the properties modeling device 602 (e.g., machine learning rules of the properties modeling device 602). For example, for a (e.g., each) chemical composition, the properties modeling device 602 may receive actual (e.g., actually measured) information of the chemical composition, calculated (e.g., thermodynamically calculated) information of the composition, predicted information of the chemical composition, identity information of the chemical composition, clinical trial and/or outcome information of the chemical composition, user-related information, environmental information, period of time information, consumer preference information of the chemical composition, etc. The properties modeling device 602 may perform an association of the information so that a prediction of chemical composition data (e.g., similar chemical composition data) may be performed.

Properties modeling device 602 may use machine learning techniques to develop a software application (e.g., a model). For example, properties engine 630 may include machine learning rules for determining (e.g., predicting) information relating to a product and/or chemical composition. Properties engine 630 may include a model (e.g., a machine learning model) to determine (e.g., predict) information regarding a product and/or chemical composition. The information provided to the model and/or the information provided by the model may be used to train the model. The information used to train the model may include names of the product, sensory and/or non-sensory attributes of the product, financial information relating to the product, identities (e.g., names, ingredients, chemoinformatic values of ingredients, etc.) of a chemical composition forming the product, values of properties of the chemical composition forming the product, features relating to the values of the properties of the chemical composition forming the product, etc. The information used to train the model may include clinical/consumer trial and/or outcome information, user-related information, consumer perception information of the chemical composition, etc. The information provided to and/or by the model to train the model may relate to chemical compositions (e.g., sample chemical compositions).

The properties engine 630 may include currently known and/or later developed machine learning rules or algorithms. The machine learning rules may be supervised machine learning rules and/or unsupervised machine learning rules. For example, the properties engine 630 may include at least one of a Random Forest rule, Support Vector Machine rule, Naïve Bayes Classification rule, Boosting rule, a variant of a Boosting rule, Alternating Decision Tree rules, Support Vector Machine rules, Perceptron rules, Winnow rules, Hedge rules, rules constructing a linear combination of features or data points, Decision Tree rules, Neural Network rules, logistic regression rules, log linear model rules, Perceptron-like rules, Gaussian process rules, Bayesian techniques, probabilistic modeling techniques, regression trees, ranking rules, Kernel Methods, Margin based rules, linear/quadratic/convex/conic/semi-definite programming techniques, or any modifications of the foregoing.

The properties engine 630 may improve its ability to perform a task as it analyzes more data related to the task. As described herein, the task may be to determine (e.g., predict) unknown information relating to a chemical composition forming a personal care product. The unknown information may be an unknown value of a property of a chemical composition, for example, from known information. The task may be to predict the value of a property of a chemical composition based on identity information of the chemical composition. The task may be to predict the value of a property of a chemical composition based on identity information and/or a feature relating to the property. The task may be to predict the identity of a chemical composition based on a value of a property of the chemical composition and/or a feature relating to the property. In such examples, the more information (relating to one or more chemical compositions) provided to the model, the better the results from the model may be. For example, the model may provide more accurate determinations of values of properties of chemical compositions based on the model receiving numerous pieces of information of the chemical compositions and information related to the identities of the chemical compositions.

As described herein, the machine learning model may be trained using a set of training examples. Each training example may include an example of an object, along with a value for the property of the object and/or a feature relating to the value for the property of the object. By processing a set of training examples that include the object, the property value for the object, and/or the feature relating to the property, the model may determine (e.g., learn) the attributes or characteristics of the object that are associated with a particular property value. This learning may then be used to predict the property or to predict a classification for other objects. As described herein, machine learning techniques (e.g., rules, algorithms, etc.) may be used to develop models for one or more products (e.g., chemical compositions forming products).

Products and/or chemical compositions (e.g., chemical compositions forming a product) may be identified and/or classified based on one or more attributes. For example, products may be identified and/or classified based on a sensory attribute (e.g., color, shape, size, taste, smell, touch, sound), a phrase (e.g., one or more words used on a label of a product), financial characteristics, etc. Chemical compositions (and/or one or more ingredients of the chemical compositions) forming a product (e.g., personal care product) may be identified and/or classified based on product, function, classification, clinical/consumer trial and/or outcome information, user-related information, form factor information of the chemical composition, packaging of the chemical composition, biomarker information, the degree and/or ways in which the product interacts with the environment, environmental features of the chemical composition, consumer perception, etc. One or more products and/or chemical compositions (and/or one or more ingredients within the chemical compositions) may be identified and/or classified prior to the product and/or chemical compositions being input into the machine learning rules. One or more products and/or chemical compositions (and/or one or more ingredients within the chemical compositions) may be identified and/or classified by machine learning rules. For example, machine learning rules may identify and/or classify products and/or chemical compositions (and/or one or more ingredients within the chemical compositions) based on sensory attributes, phrases, product category, function, classification, clinical/consumer trials, consumer perception, etc.

Models (e.g., machine learning models) may be developed to receive information relating to a product and/or chemical composition forming the product, for example, to determine (e.g., predict) information relating to a product and/or chemical composition forming the product. Training examples (e.g., training sets or training data) may be used to train the properties engine 630. For example, the training data may include the names of sample products, attributes (e.g., sensory attributes, phrases, etc.) relating to a product, financial characteristics relating to a product, sample chemical compositions, ingredients of sample chemical compositions, chemoinformatic values of ingredients of sample chemical compositions, fitting parameters of sample chemical compositions, functions of sample chemical compositions, classifications of sample chemical compositions, values of properties of sample chemical compositions, etc.

The values of properties of sample chemical compositions may be determined via calculations, such as via thermodynamic calculations. The values of properties of sample chemical compositions may be determined via an experimental measurement. As described herein, properties of sample chemical compositions may include the pH, fluoride stability, viscosity stability, abrasion, specific gravity, clinical/consumer trial and/or outcome information, user-related information, form factor information of the chemical composition, packaging of the chemical composition, biomarker information, the degree and/or ways in which the product interacts with the environment, environmental features of the chemical composition, consumer perception properties, etc. of the sample chemical composition.

After training the properties engine 630 (e.g., the machine learning model of properties engine 630) using training data, the properties engine 630 may be used to determine (e.g., predict) data. For example, the properties engine 630 may be used to determine (e.g., predict) parameters that are similar to the parameters used to train the properties engine 630.

As an example, properties engine 630 may be trained using identities (e.g., ingredients) of chemical compositions and values of a pH property of chemical compositions. The properties engine 630 may be used to determine unknown values of a pH property, for example, based on the identity (e.g., ingredients) of a chemical composition. In another example, properties engine 630 may be trained using identities (e.g., ingredients) of chemical compositions, values of outcomes of a teeth whitening clinical study, and one or more features related to the teeth whitening clinical study, such as time periods related to the outcomes of the teeth whitening clinical study. Based on an identity (e.g., ingredients) of a chemical composition, the properties engine 630 may be used to determine unknown values of outcomes of teeth whitening clinical studies at one or more time periods.

As another example, properties engine 630 may be trained using sensory (e.g., color of product, taste of product) attributes and/or non-sensory (e.g., text on packaging, ingredients) attributes of a product, financial (e.g., market) data relating to the product, etc. The properties engine 630 may be used to determine unknown values of text to use on packaging of a product to produce a profitability of a defined value, or vice-versa. In other examples, the properties engine 630 may be used to determine unknown values of a color, taste, and ingredients to use with a product to produce a market share of a defined value, and vice-versa. The properties engine 630 may be used to determine sensory and/or non-sensory attributes of a product within a predefined amount of a financial data, such as determining a color and taste of a product to produce a profitability of a defined amount, as well as ten percent above that defined amount and below that defined amount.

As another example, after training properties engine 630 using training data, properties engine 630 may be used to generate a product using terms used to train the training properties engine 630. For example, properties engine 630 may be trained using ingredients of products formed of chemical compositions, sensory attributes, non-sensory attributes, and financial (e.g., market) data. The properties engine 630 may be used to determine (e.g., identify) a product based on one or more sensory attributes. For example, the properties engine 630 may be used to determine a product (e.g., determine a chemical composition forming a product) based on the product being infused with coconut oil and being warm and soft to the touch. As another example, the properties engine 630 may be used to determine a product (e.g., determine a chemical composition forming a product) based on the product comprising charcoal, providing whitening benefits to teeth, and having a profitability of (and/or within) a predefined amount. The properties engine 630 may determine a product based on a category, such as determining a product based on the product being a toothpaste, shampoo, moisturizer, and the like. The properties engine 630 may determine a product based on a region, such as determining a product based on the product having a market value of a first predefined amount in North America, having a second predefined amount in Europe, and/or having a third predefined amount in Asia.

In another example, after training the properties engine 630 (e.g., the machine learning model of properties engine 630) using training data, the properties engine 630 may be used to determine parameters that are different than the parameters used to train the properties engine 630. As an example, properties engine 630 may be trained using identities (e.g., ingredients) of chemical compositions and values of a pH property of chemical compositions. The properties engine 630 may be used to determine unknown values of a soluble zinc property. The properties engine 630 may be used to determine unknown values of a soluble zinc property based on the identity (e.g., ingredients) of the chemical composition. The different parameters may have a relationship with one another. The relationship between the different parameters may allow the properties engine 630 to predict the different parameters. Using the example above, although the pH property and the soluble zinc property are different properties, there may be a relationship with the pH property and the soluble zinc property that allows the properties engine 630 to predict the soluble zinc data based on pH training data.

Other data related to a chemical composition may be used to train the properties engine 630. For example, features (e.g., data) related to a property may be used to train the properties engine 630. As an example, the data related to the property may be user-related information associated with the value of the property, environmental data associated with the value of the property, period of time data associated with the value of the property, a fitting parameter associated with the value of the property, although other types of data may be used to train the properties engine 630. As an example, training data may include an identity (e.g., a name, ingredients, and/or chemoinformatic values of ingredients) of sample chemical compositions and fitting parameters of sample chemical compositions.

A fitting parameter may be used to determine a value of a parameter at a defined instance. For example, the fitting parameter may relate to the rate at which a value changes over time. The fitting parameter may be used to determine a value of a parameter at a future date, day, time, time period, etc. A fitting parameter may be used to define continuous functions. A fitting parameter may be used to determine a value of a property at one or more (e.g., any) point in time. For example, if a value of fluoride stability has been measured at 4, 8, and 13 weeks, a fitting parameter may be derived which may provide values (e.g., expected values) of fluoride stability at intermediate timepoints between 4, 8, and 13 weeks and/or at extended points beyond 13 weeks.

A fitting parameter may be used to determine a value of a feature relating to a property of the composition. For example, a fitting parameter may be derived that provides values (e.g., expected values) of clinical outcomes at one or more time periods. The clinical outcomes may relate to products, such as personal care products, foodstuffs, pharmaceuticals, etc. For example, a fitting parameter may be derived that provides clinical outcomes for gingivitis reduction over a three or six month period, that provides clinical outcomes for tooth whitening over several days to several months, that provides clinical outcomes for sensitivity relief over several minutes to several months, and/or that provides clinical outcomes for wrinkle reduction over a ninety-day period. In other examples a fitting parameter may be derived that provides clinical outcomes for weight loss (e.g., of a person or animal) over a six-week period, a reduction of a medical condition (e.g., increased blood pressure) over an eight week period, etc.

Determining a value of a property at a future date, day, time, time period, etc. may be useful as manufacturers of products (e.g., personal care products) may be required to demonstrate that a product (e.g., personal care product) maintains a minimum threshold quantity of a property throughout the shelf-life of the product. For example, as shelf lives of a product may be on the order of several years, it may be impractical to test products (e.g., new products) at certain time periods (e.g., months, years, etc.) to determine the viability of the products. It may be useful to collect data (e.g., collect data over a short period of time) and use a fitting parameter to extrapolate the value of the property at a longer period of time. Such a model (e.g., a model which predicts fitting parameters) may predict properties at timepoints for which there may be no experimental data. The feature relating to the property may include period of time (e.g., timepoint) data corresponding to the shelf-life of the product, although the feature may be data other than period of time data in examples.

A properties engine 630 may be trained using data related to a chemical composition. As described herein, the data may be an identity (e.g., ingredients) of the chemical composition as well as other data. For example, the properties engine 630 may be trained using ingredients of chemical compositions, molecular weights of the ingredients (e.g., each ingredient), weight percentages of the ingredients (e.g., each ingredient), etc. The weight percentages of the ingredients (e.g., each ingredient) may be converted to a molar concentration. The properties engine 630 may be trained using molar concentrations, theoretical total fluoride content, and/or soluble fluoride after aging of a chemical composition (e.g., after aging of a chemical composition for 13 weeks at 40 degrees Celsius). After training the properties engine 630 (e.g., the machine learning model of properties engine 630) using training data, the properties engine 630 may be used to determine (e.g., predict) data. For example, the properties engine 630 may be used to determine (e.g., predict) a value for soluble fluoride after aging, based on an identity (e.g., ingredients) of a chemical composition and/or based on molecular concentration data related to the chemical composition.

A fitting parameter may be used to determine a value of a parameter at a future time period. The future time period may be a feature relating to the property. For example, the properties engine 630 may be trained using ingredients of chemical compositions, molecular weights of the ingredients (e.g., each ingredient), weight percentages of the ingredients (e.g., each ingredient), and/or the fitting parameter. After training the properties engine 630 (e.g., the machine learning model of properties engine 630) using ingredients of chemical compositions, molecular weights of the ingredients (e.g., each ingredient), weight percentages of the ingredients (e.g., each ingredient), and/or the fitting parameter, the properties engine 630 may be used to determine the fitting parameter. The fitting parameter may be used with a fitting function to determine a defined instance, as described herein. For example, the properties engine 630 may be used to determine (e.g., predict) a value of a fitting parameter that can be used with a fitting function to determine the theoretical total fluoride content and/or the soluble fluoride content measured after aging of a chemical composition (e.g., after aging of a chemical composition at 4, 8, and/or 13 weeks at 40 degrees Celsius). Example fitting functions may include an exponential function, polynomial function, power function, trigonometric function, although other fitting functions may be used.

Information included in the training data may be selected and/or input into the model of properties engine 630 based on a function and/or classification. For example, a chemical composition and/or an ingredient of a chemical composition may have a defined function and/or classification, such as an ingredient in a chemical composition having a binding function, a preserving function, a whitening function, an alcohol classification, an ethers classification, etc. The function may relate to how one or more of the ingredients of the chemical composition are used in product form. The function may relate to a pellicle cleaning ratio (PCR) and/or a relative dentin abrasivity (RDA).

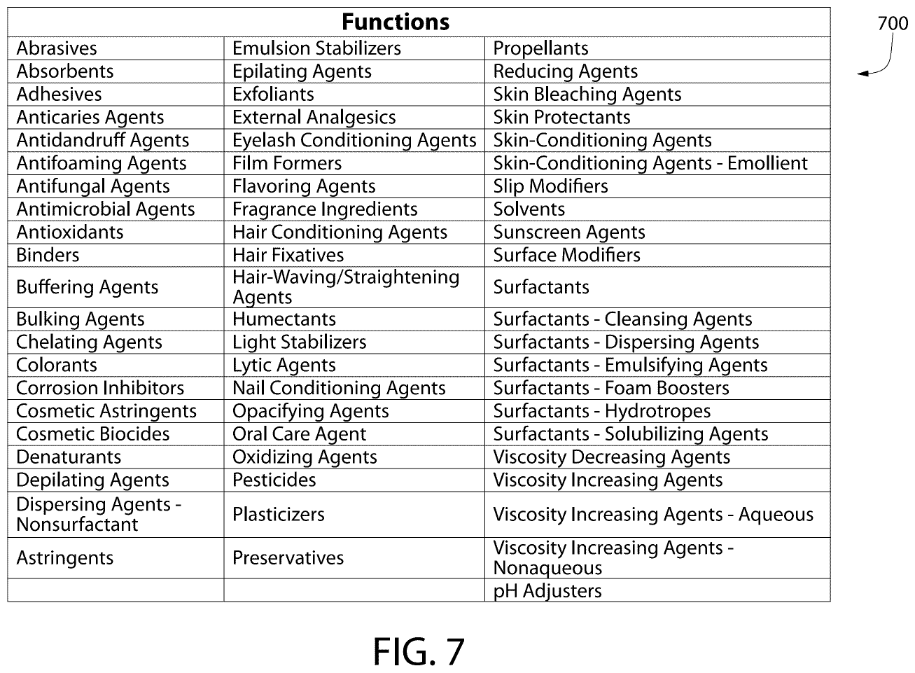

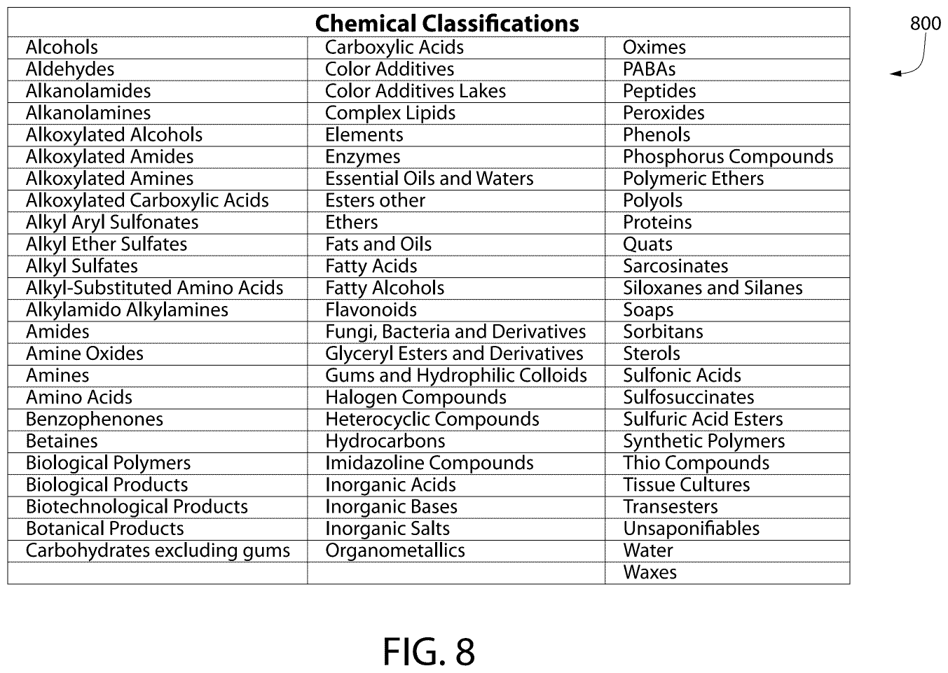

PCR is a measurement of stain removal and may represent the cleaning efficacy of a personal care product, such as a toothpaste. RDA is a measurement of abrasivity (e.g., pure abrasivity) and may represent the erosive capability of a personal care product, such as a toothpaste. Example functions 700 of a chemical composition and/or an ingredient within the chemical composition may be found in FIG. 7. Example classifications 800 of a chemical composition and/or an ingredient within the chemical composition may be found in FIG. 8. Although FIG. 7 and FIG. 8 provide a list of functions and classifications, respectively, it should be understood by those of skill in the art that the functions provided in FIG. 7 and the classifications are provided in FIG. 8 are for example purposes only and are non-limiting.

In examples, one or more chemical compositions may (e.g., may only) be input into a model if the chemical compositions have a function (e.g., a desired function). As an example, a set may consist of eighty chemical compositions. Of the eighty chemical compositions, fourteen chemical compositions may include an ingredient that provides a function of whitening. A user may desire to determine a value of a property of a chemical composition wherein the chemical composition (e.g., an ingredient of the chemical composition) may have a whitening function. In such an example, the model may be trained using (e.g., only using) chemical compositions (e.g., ingredients of the chemical composition) having a whitening function, such as the fourteen chemical compositions in the above example. Also, or alternatively, the model may categorize (e.g., automatically categorize, dynamically categorize, etc.) chemical compositions based on the function of the chemical composition.

With the model including (e.g., only including) chemical compositions of a defined function, or the model categorizing chemical compositions based on a defined function, the properties engine 630 may provide information of a chemical composition having (e.g., only having) the function. For example, the properties engine 630 may determine a value of a property of a chemical composition having a function (e.g., a flavoring function, a binding function, etc.) based on an identity of the chemical composition. Conversely, the properties engine 630 may determine an identity of a chemical composition having a function based on a value of a property of the chemical composition.

In other examples, one or more chemical compositions may (e.g., may only) be input into a model if the chemical compositions have a classification (e.g., a chemical classification). The classification may relate to molecular properties of an ingredient of a chemical composition, such as a chemical composition forming a personal care product. The chemical compositions may (e.g., may only) be input into a model if the chemical compositions have a desired classification. Example chemical classifications may include an alcohols classification, an amino acids classification, an enzymes classification, a fatty acids classification, a ketones classification, peptides classification, as well as other classifications provided in FIG. 8.

As an example, a set may consist of forty chemical compositions. Of the forty chemical compositions, ten chemical compositions may include an ingredient that is classified as an ether. A user may desire to determine a value of a property of a chemical composition wherein the chemical composition (e.g., an ingredient of the chemical composition) may have a classification of an ether. In such an example, the model may be trained using (e.g., only using) chemical compositions (e.g., ingredients of the chemical composition) having a classification of an ether. Also, or alternatively, the model may categorize (e.g., automatically categorize, dynamically categorize, etc.) chemical compositions based on the classifications of the chemical composition.

With the model including (e.g., only including) chemical compositions of a defined classification, or the model categorizing chemical compositions based on a defined classification, the properties engine 630 may provide information of a chemical composition having (e.g., only having) the classification. For example, the properties engine 630 may determine a value of a property of a chemical composition having a classification (e.g., an alcohols classification, a fatty acids classifications, etc.) based on an identity of the chemical composition. Conversely, the properties engine 630 may determine an identity of a chemical composition having a classification based on a value of a property of the chemical composition.

As described herein, information relating to one or more chemical compositions may be input into the model based on a function, classification, clinical/consumer trial, consumer perception, etc., of the chemical composition and/or ingredient of the chemical composition. Information (e.g., identities, values of properties, etc.) of chemical compositions may be identified based on experimentation, simulation, mathematical computations, analysis, clinical/consumer trials, and/or assumptions regarding the property being modeled. For example, actual (e.g., actually measured) values of properties of chemical compositions may be identified and input into the model.

A training set (e.g., identities of products and/or chemical compositions along with associated values of properties of the products and/or chemical compositions) may be used to train a machine learning model (e.g., properties engine 630). The machine learning model (e.g., properties engine 630) may perform a selected machine learning rule or algorithm using the training set, as described herein. Once trained, the model may be used to determine (e.g., predict) the identity and/or values of properties of the chemical composition, relative to the property of interest.

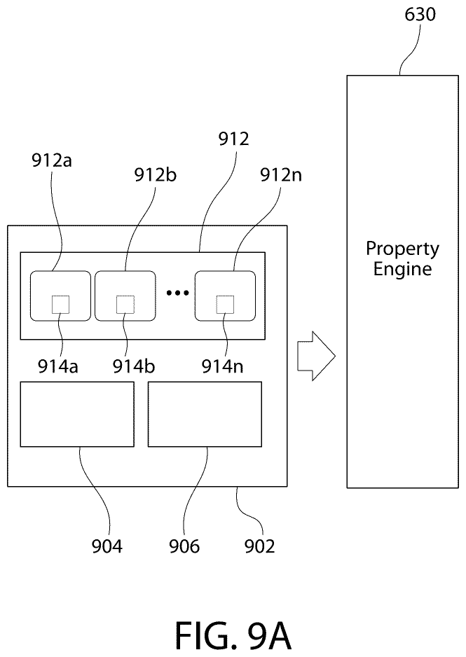

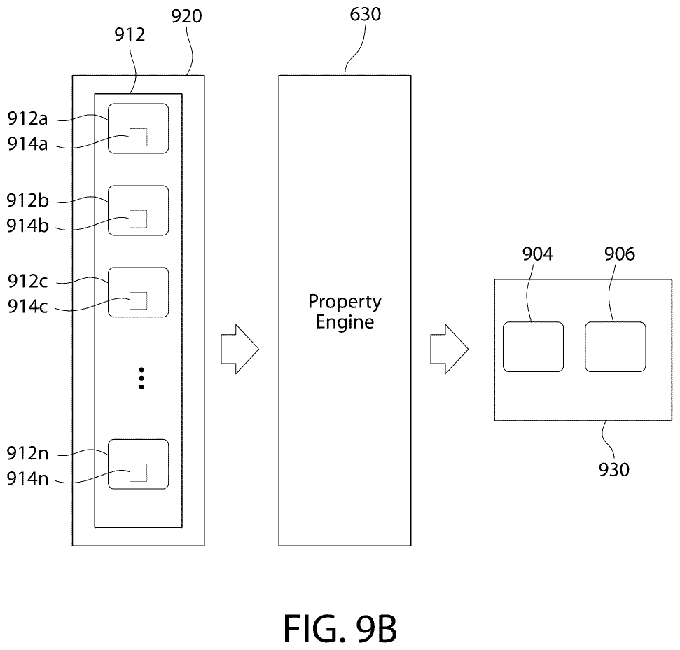

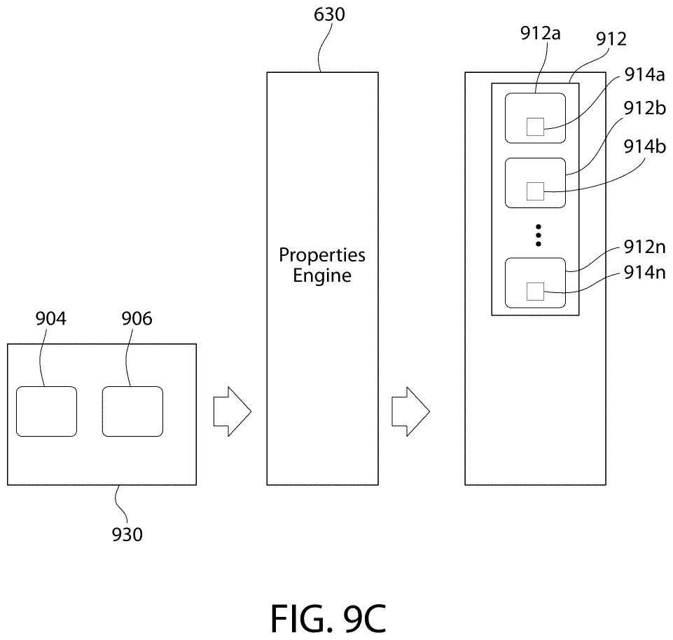

FIG. 9A shows a block diagram of example data used for training properties engine 630. Data 902 may relate to one or more products and/or chemical compositions (e.g., sample chemical compositions). Data 902 may be known and/or determined. For example, data 902 may be known by experimentally measuring the data, mathematically calculating (e.g., via thermodynamic calculations) the data, receiving the data from storage (e.g., from a database, such as a properties database 624), receiving the data from clinical trials, receiving data from product marketing teams, receiving data from market analysis, etc. Data 902 may include values for one or more parameters. For example, data 902 may include identities of products and/or chemical compositions. Identities may include the names of the products, chemical compositions forming the products, ingredients of the chemical compositions, chemoinformatic values/properties of the ingredients of the chemical compositions, values of properties of the chemical compositions, values of features relating to properties of the chemical compositions, consumer perceptions of the chemical compositions, sensory/non-sensory attributes of products, financial characteristics of products, etc. Data may be input into the properties engine 630, for example, to train the model to predict one or more values of chemical compositions.

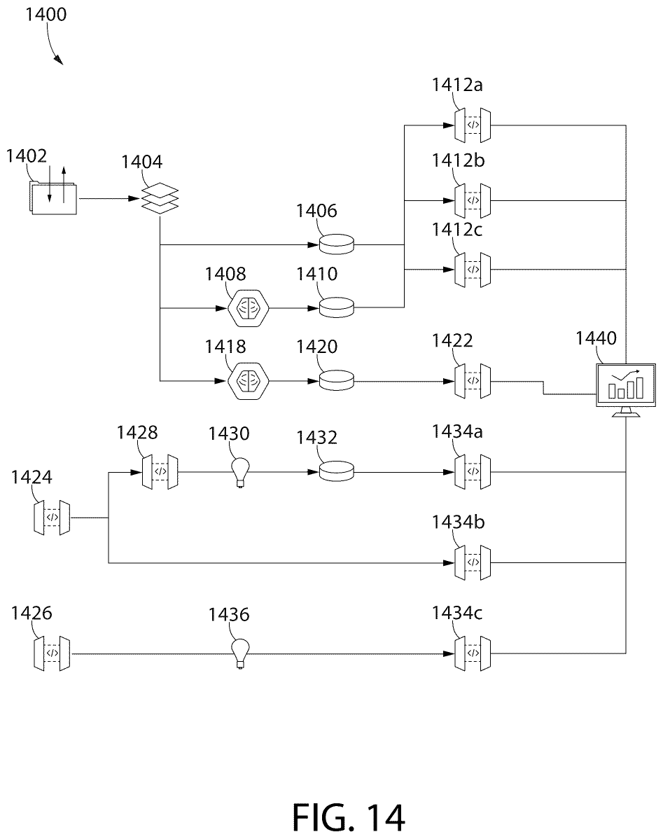

FIG. 14 shows an example system 1400 in which product data may flow from one or more sources to an output, such as a presentation board (e.g., vision board) 1440. Product data may be provided by one or more sources, such as product database 1402. The product data may be saved in a database, such as database 1404. The product data may be cleaned and saved in the database 1406. The product data saved in database 1406 may be considered master product data. Text from images of products may be stripped (e.g., stripped from a label on the product, a marketing campaign, etc.), translated, and/or saved (e.g., saved to a database or a server, such as server 1408). Additional data relating to the product may be stripped, translated, or saved to database 1410. The additional data may include sensory attributes (e.g., colors, shapes, sizes, smells, tastes, sounds) of the product and/the packaging housing the product, and the like. The data may proceed through one or more APIs, such as trend migration API 1412a, leaderboard API 1412b, market trends API 1412c, and the like.

Data may be provided (e.g., provided via product database 1402) to an external device, such as external server 1418. External server 1418 may perform one or more operations upon the data, such as extracting a benefit (e.g., function) of the product, a benefit of the ingredients comprising the product, and the like. The extracted data may be saved to one or more databases, such as database 1420. The extracted data may be processed. For example, the extracted data may be processed via semantic API 1422, which may determine and/or provide terms that are similar to the extracted terms. Semantic API 1422 may use lookup techniques (such as thesaurus techniques), to determine and/or provide terms that may be similar to the extracted term.

Data may be provided via a service providing predefined data, such as data provider 1424 and/or data provider 1426. In an example, data provider 1424 may be a real-time search results APA and/or API 1426 may be an API configured to handle massive datasets and high-volume streams of textual data (e.g., unstructured and/or structured textual data). Data provided by data provider 1424 and/or data provider 1426 may be processed by a data processor, such as QNet API 1428. The processed data may be analyzed via one or more analyzers, such as Network Analyzer 1430. Queries may be provided. For example, queries may be provided via a database, such as questions database 1432. The data (e.g., data in which queries are provided) may be correlated with one or more APIs, such as QNet API 1434a, Google trends API 1434b, and/or Social API 1434c. Social API 1434c may be a social networking API. As described herein, data may be provided via API 1426. The data may be processed via language processor 1436, which may extract one or more types of information from the data. For example, language processor 1436 may extract entity information from the data. The data may be correlated with an API, such as Social API 1434c.

As shown in FIG. 9A, data 902 may include one or more ingredients 912 of one or more chemical compositions (e.g., chemical compositions forming a product). Ingredients may include a first ingredient 912a, a second ingredient 912b, etc. Example ingredients are provided in FIGS. 1A, 1B and 2A, 2B. For example, a chemical composition may include water, glycerin, propylene glycol, and flavor ingredients. In such example, data 902 may include data for water, glycerin, propylene glycol, and flavor ingredients. Each ingredient 912a, 912b, etc., may include an identity of the ingredient and/or a chemoinformatic value for the ingredient. For example, data 902 may include chemoinformatic values 914a, 914b, etc. In the example chemical composition that includes glycerin, propylene glycol, and flavor ingredients, each of glycerin, propylene glycol, and flavor will have a respective chemoinformatic value within data 902.

Data 902 may include a value 904 of a property of the chemical composition. The value 904 of the property may be affected by one or more of the ingredients. For example, the value 904 of the property may be affected by one or more of the ingredients interacting with one or more other ingredients of the chemical composition. A property may be pH, fluoride stability, viscosity stability, abrasion, specific gravity, clinical/consumer outcomes and/or trials, user-related information, environmental features, a consumer perception of the chemical composition, etc. Data 902 may include a value of the property, such as a value of a pH property. As described herein, the value of the property (e.g., pH property) may be affected by one or more of the ingredients of the chemical composition.

Data 902 may include a value 904 of a property of a product. A property may be a sensory attribute of a product, a non-sensory attribute of a product, a financial characteristics of a product, etc. Data 902 may include a value of the property, such as a value of a sensory attribute.

Data 902 may include a value 906 of a feature relating to one or more properties of the product (e.g., chemical composition forming a product). For example, a value 904 of a property may relate to clinical/consumer trial and/or outcome data, etc. The value 904 of the property relating to the clinical trial and/or clinical outcome data may be a consumer perceived liking of a product (e.g., fragrance), a clinical whitening efficacy of a toothpaste, a hydrating ability of a skin cream, etc. The value 906 of the feature relating to the property may be a formulation attribute (e.g., an oxidation potential of the chemical composition), a period of time (e.g., the value of the tooth whitening at six weeks of use, eight weeks of use), user-related data (e.g., the age of the consumer using the chemical composition, the geographic data related to the consumer, the brushing habits of the user, etc.), and the like.

One or more values of data 902 may be input into the properties engine 630, for example, to train the properties engine 630. Identities of chemical compositions, associated values of properties (e.g., other properties) of the chemical compositions, and/or features relating to the properties may be input into the properties engine 630. As an example, ingredients of chemical composition (e.g., sample chemical composition) and associated values of properties may be input into the properties engine 630. The properties engine 630 may provide an association of the ingredients of the chemical compositions and the values of properties of the chemical compositions. In another example, ingredients of chemical composition (e.g., sample chemical composition), associated values of properties, and features relating to the properties may be input into the properties engine 630. The properties engine 630 may provide an association of the ingredients of the chemical compositions, the values of the properties of the chemical compositions, and the features relating to the properties of the chemical compositions.

FIG. 9B shows a block diagram of example data 920 used for determining information relating to a product (e.g., chemical composition forming the product) using properties engine 630. For example, FIG. 9B shows a block diagram of example data 920 used for determining a value 904 of a property and/or a value 906 of a feature relating to the property via properties engine 630. Data 920 may relate to one or more products and/or compositions (e.g., chemical compositions, such as considered chemical compositions). Data 920 may be known and/or determined. For example, data 920 may be known and/or determined by receiving the data from storage (e.g., from a database, such as a properties database 624), experimentally measuring the data, mathematically calculating (e.g., via thermodynamic calculations) the data, receiving the data via surveys or clinical trials, etc.

Data 920 may include values for one or more parameters. Data 920 may include identities of products and/or chemical compositions, such as the names of the chemical compositions, ingredients 912 of the chemical compositions, chemoinformatic values/properties of the ingredients of the chemical compositions, values of properties of the chemical compositions, values of features relating to the properties of the chemical compositions, values of sensory/non-sensory attributes of products, values of financial characteristics of products, etc. Data 920 may be input into the properties engine 630, for example, to determine from the properties engine 630 (e.g., machine learning model of properties engine 630) one or more values 904 of properties of chemical compositions and/or values 906 of features relating to properties of chemical compositions.

As shown on FIG. 9B, data 920 may include one or more ingredients 912 of one or more chemical compositions. Ingredients 912 may include a first ingredient 912a, a second ingredient 912b, etc. For example, a chemical composition may include water, glycerin, propylene glycol, and flavor ingredients. In such example, data 920 may include data for water, glycerin, propylene glycol, and flavor ingredients. Each ingredient 912a, 912b, etc., may include a chemoinformatic value for the ingredient. For example, data 902 may include chemoinformatic values 914a, 914b, etc. In the example chemical composition that includes glycerin, propylene glycol, and flavor ingredients, each of glycerin, propylene glycol, and flavor will have a respective chemoinformatic value within data 920.

One or more values of data 920 may be input into the properties engine 630, for example, to determine (e.g., determine from the properties engine 630) a value 904 of a property of the chemical composition and/or a value 906 of a feature relating to a property of chemical compositions. For example, ingredients 912 of a chemical composition (e.g., a sample chemical composition) may be input into the properties engine 630. The properties engine 630 may run (e.g., process) one or more machine learning rules to determine a value 904 of a property of the chemical composition. The properties engine 630 may provide the value 904 of the property of the chemical composition after determining the value.

In another example, ingredients 912 of a product and/or chemical composition (e.g., a sample chemical composition) may be input into the properties engine 630 and one or more features relating to one or more properties of the product and/or chemical composition may be input into the properties engine 630. The properties engine 630 may run (e.g., process) one or more machine learning rules to determine a value 904 of a property of the product and/or chemical composition. The value of the property may be associated with the feature (e.g., the value of the clinical whitening efficacy may be associated with the feature of clinical participants being under a predefined age). The properties engine 630 may provide the value 904 of the property of the product and/or chemical composition after determining the value.

Properties engine 630 (e.g., model of properties engine 630) may be configured to predict a value of a property of the product and/or chemical composition, for example, based on receiving identities of ingredients of a product and/or chemical composition and/or features relating to the value of the property of the product and/or chemical composition, etc. In an example, the values of the properties of the product and/or chemical composition may be affected by ingredients of the product and/or chemical composition (e.g., may be affected by an interaction of one or more of the ingredients of the chemical composition forming the product) and/or by values of features related to the properties of the product and/or chemical composition.

When information relating to a product and/or chemical composition is supplied to the trained model, the output may comprise a prediction regarding the value of the property of the product and/or chemical composition, features relating to the property, a fitting parameter associated with the chemical composition, identities of the chemical composition, etc. The property may relate to a pH of the chemical composition, a viscosity stability of the chemical composition, an abrasion of the chemical composition, a specific gravity of the chemical composition, a clinical/consumer trial and/or outcome, a consumer perception of the chemical composition, a sensory and/or non-sensory attribute, a financial characteristic, etc. Features related to the property may relate to user-related values, environmental factors, etc. The predictions may take the form of a value from a continuous range of values or from a discrete value, for example.

FIG. 9C shows a block diagram of example data 930 used for determining an identity of a product and/or chemical composition via properties engine 630. Data 930 may relate to one or more products and/or chemical compositions (e.g., considered products and/or chemical compositions). Data 930 may be known. For example, as described herein, data 930 may be known by experimentally measuring the data, mathematically calculating (e.g., via thermodynamic calculations) the data, receiving the data via a clinical/consumer trial, receiving the data from storage (e.g., from a database, such as a properties database 624), etc. As shown in FIG. 9C, data 930 may include a value 904 of a property of a chemical composition, a value 906 of a feature relating to the property of the chemical composition, etc. Data 930 may be input into the properties engine 630, for example, to determine information (e.g., associated information) of products and/or chemical compositions. For example, data 930 (e.g., value 904) may be input into the properties engine 630 to determine, from the model, ingredients 912 of the products and/or chemical composition determined (e.g., predicted) to relate to the value 904 of the property input into the properties engine 630.

As described herein, data 930 may include a value 904 of a property, a value 906 of a feature relating to the property, etc. The value 904 of the property and/or the value 906 of the feature relating to the property may be input into properties engine 630, for example, to predict (e.g., determine) a name of a product and/or chemical composition, one or more ingredients 912 of a product and/or chemical composition, chemoinformatic values 914a, 914b, . . . , 914n of a chemical composition forming a product, etc. Ingredients may include a first ingredient 912a, a second ingredient 912b, etc. For example, a chemical composition may include water, glycerin, propylene glycol, and flavor ingredients. A chemoinformatic value may be associated with an (e.g., each) ingredient 912a, 912b, etc. For example, ingredient 912a may include chemoinformatic value 914a.

As an example, a value 904 of a property of a product and/or chemical composition and/or a value 906 of a feature relating to the property may be input into properties engine 630. Based on value 904 of the property of the product and/or chemical composition and/or the value 906 of the feature relating to the property, the properties engine 630 (e.g., model of properties engine 630) may be configured to predict identities (e.g., names, ingredients, chemoinformatic values, etc.) of a product and/or chemical composition forming a product (e.g., personal care product). When information relating to a product and/or chemical composition is supplied to the properties engine 630, the output may comprise a determination (e.g., prediction) regarding the identities (e.g., names, chemoinformatic values, etc.) of a product and/or chemical composition forming the personal care product, a fitting parameter associated with the product and/or chemical composition, a value (e.g., another value) of a property of the chemical composition, a feature relating to the property, etc. The properties engine 630 may provide the names, ingredients, chemoinformatic values, etc. of the product and/or chemical composition to user via user device 502, for example.

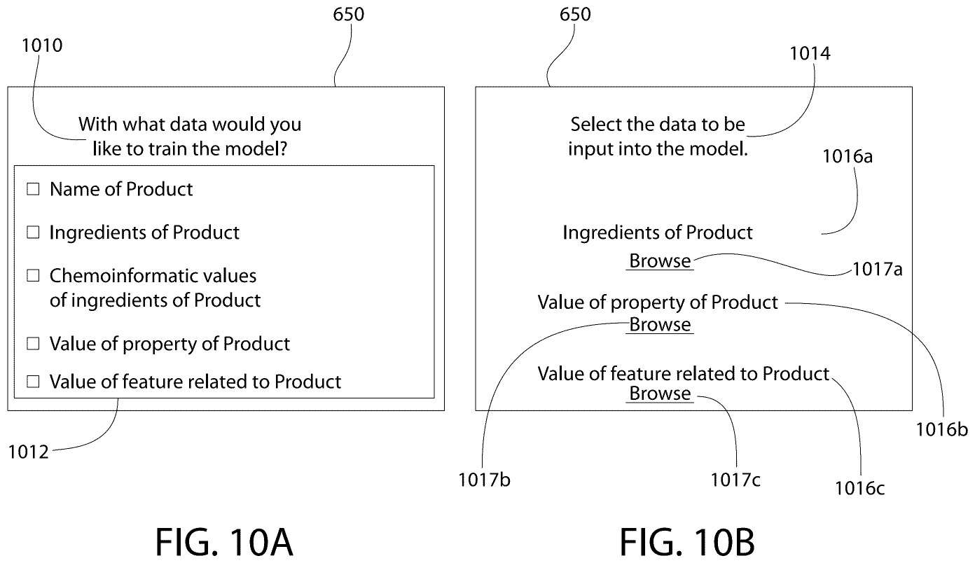

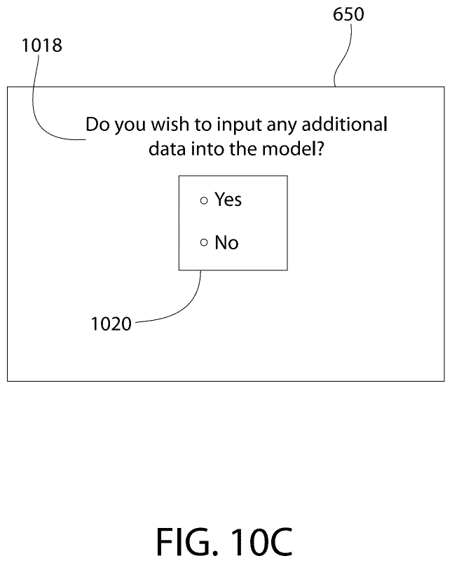

FIGS. 10A-10C show example graphical user interfaces (GUIs) for training a properties modeling device 602 (e.g., a properties engine 630 within properties modeling device 602). The GUI may be displayed on one or more devices. For example, the GUI may be displayed on a training device, such as training device 650, a user device, etc.

As shown in FIG. 10A, the GUI may request information from the user, for example, the GUI may request information from the user via prompt request 1010. Prompt request 1010 may ask the user what data the user would like to use to train the properties engine 630 (e.g., model of properties engine 630). The data used to train the model may be referred to as sample data. The data may include an identity (e.g., name, ingredients, chemoinformatic values of ingredients) of a product and/or chemical composition forming a personal care product, a value of a property of personal care product, a value of a feature relating to the property, etc. The GUI may provide an input mechanism 1012 for the user to provide a response to prompt request 1010. For example, the GUI may have a text box for receiving text from the user, a radio button for selection, etc. As shown in FIG. 10A, check box 1012 may be provided. In examples in which a text box is provided, the user may check one or more of the data in the input mechanism 1012 for training the properties engine 630.

After the user selects the data desired to be input into the properties engine 630 (e.g., for training the properties engine 630), the user may input such data. The user may input the data manually (e.g., via manually typing or speaking the data). The user may input a single piece of data or the user may input multiple pieces of data. For example, the user may input an identity (e.g., ingredients) of a product and/or chemical composition, a property of the product and/or chemical composition, and/or a feature relating to the property. As shown in FIG. 10B, GUI may provide an indication for the user to select the data to be input into the properties engine 630. The GUI may display the data to be input into the properties engine 630, For example, the GUI may display the data to be input into the properties engine 630 based on the input provided on input mechanism 1012 of FIG. 10A.

In an example, the user may desire to input ingredients 1016a of a chemical composition forming a product (e.g., a personal care product, a foodstuff, a pharmaceutical, etc.), a value 1016b of a property of a product and/or chemical composition forming the product, and/or a value 10616c of a feature relating to the property. As shown in FIG. 10B, the user may select a file to provide the ingredient information (via Browse 1017a), the value (via Browse 1017b) of the property information, and/or the value (via Browse 1017c) information relating to the property. Although FIG. 10B shows a Browse button for inputting data, one of skill in the art will understand that other methods exist for selecting and/or inputting data into properties engine 630, such as via a database (such as a database housed on a server, such as a cloud server), via one or more hard drives, via external devices (such as user device 502), etc.

The user may input data into the properties engine 630 for one or more chemical compositions. For example, the user may train the properties engine 630 with data relating to tens, hundreds, thousands, etc., of product and/or chemical compositions. The user may train the properties engine 630 with the same data for one or more of the products and/or chemical compositions. For example, the user may train the properties engine 630 with ingredients and values of properties of dozens of products and/or chemical compositions.

The user may train the properties engine 630 with different data (e.g., types of data) for one or more of the products and/or chemical compositions. For example, the user may train the properties engine 630 with ingredients, values of properties, and/or values of features relating to the values of properties for some of the products and/or chemical compositions; with chemoinformatic values, values of properties, and/or values of features relating to the properties for some of the products and/or chemical compositions; with names of products and/or chemical compositions, values of properties, and/or values of features relating to the values of properties for some of the products and/or chemical compositions, etc.

The user may train the properties engine 630 with values of properties comprising a pH, a fluoride stability, a viscosity stability, an abrasion, a specific gravity, clinical/consumer trials and outcomes, user-related data, consumer perceptions, sensory attributes, non-sensory attributes, financial characteristics, etc. The training device 650 (e.g., GUI of training device) may request if the user desires to input additional data. For example, as shown in FIG. 10C, the GUI may provide an additional data prompt 1018 asking the user if the user desires to input any additional data into the properties engine 630 (e.g., the model of properties engine 630). The user may desire to input additional data into properties engine 630 if the user desires to further train the properties engine 630. If the user desires to input additional data into the properties engine 630, the user may select the Yes prompt in area 1020, otherwise the user may select the No prompt in area 1020. If the user selects the Yes prompt in area 1020, the GUI shown in FIG. 10B (and described herein) may be provided to the user. If the user selects the No prompt in area 1020, the user may exit the GUI.

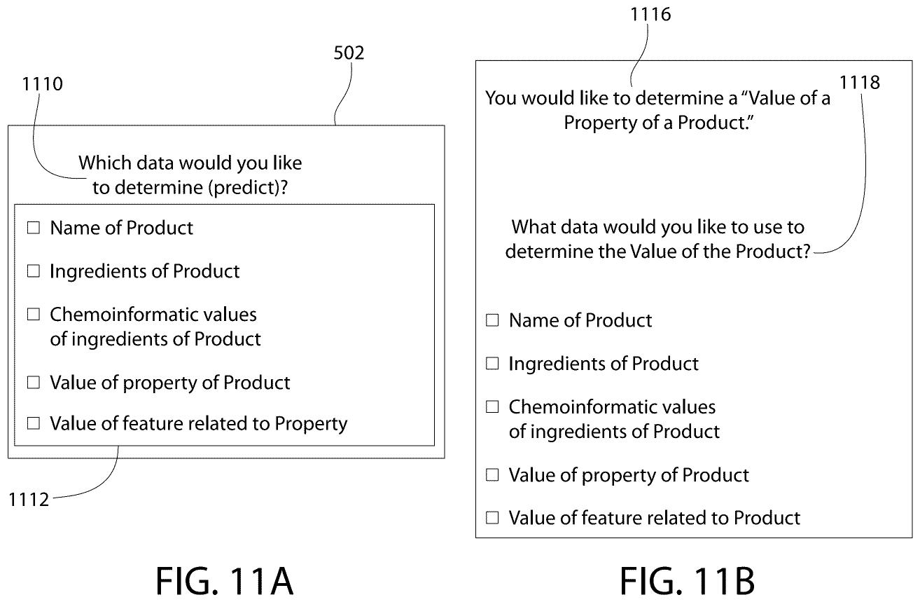

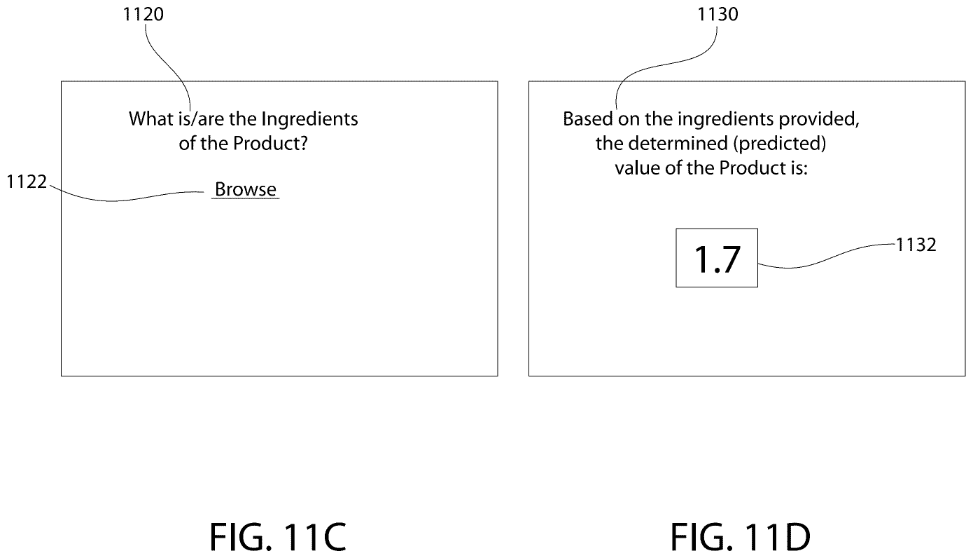

FIGS. 11A-11D show example graphical user interfaces (GUIs) for determining (e.g., predicting) data from a properties modeling device 602 (e.g., a properties engine 630 within properties modeling device 602). The GUI may be displayed on one or more devices. For example, the GUI may be displayed on a user device, such as user device 502.

As shown in FIG. 11A, the GUI may request information from the user, for example, via prompt request 1110. Prompt request 1110 may ask the user what data the user would like the model to determine (e.g., predict). The GUI may provide an input mechanism 1112 for the user to provide a response to prompt request 1110. For example, the GUI may have a text box for receiving text from the user, a radio button for selection, etc. As shown in FIG. 11A, check box 1112 may be provided. The user may check one or more of the data in the input mechanism 1112 so that the properties engine 630 may determine one or more pieces of data relating to the chemical composition. Input mechanism may permit additional information, including sub-categories of information, to be selected for determination. Sub-categories of information may include values of features related to properties of the chemical composition. Input mechanism 1112 may allow a user to define the value of the property to be determined to be one a pH, a fluoride stability, a viscosity stability, an abrasion, a specific gravity, a clinical trial and/or outcome, a consumer perception, etc.

After the user selects what data the user desires the properties engine 630 to determine, the user may input data that is associated with the desired data, as shown in FIG. 11B. For example, prompt 1116 indicates that the user desires to determine a value of a property of the chemical composition (based on the user's input at input 1112, in FIG. 11A). As shown in FIG. 11B, the GUI may provide input 1118, allowing the user to select what data the user desires to input into the properties engine 630, for example, to determine the value of the property of the product and/or chemical composition. Examples of data to be input into the properties engine 630 includes identity (e.g., name, ingredients, chemoinformatic values of ingredients) data of a product and/or chemical composition forming a product (e.g., a personal care product), a value of a property of personal care product, etc. Additional data, such as one or more values of features relating to the property may be input into properties engine 630 to determine one or more values of properties of a product.

After the user selects the data that the user desires to determine (1112), and the data that the user would like to use to determine the value of the personal care product (1118), the user may provide the associated data. FIG. 11C shows an example GUI in which user may at input data, at 1122. Prompt 1120 indicates that the user has chosen to input ingredients of the product and/or chemical composition forming the product (to determine a value of a property of the product and/or chemical composition forming the product), however such indication is for illustration purposes only and other types of data may be provided by user to determine information relating to a product and/or chemical composition.

The user may input the data manually (e.g., via manually typing or speaking the data). For example, the user may input the ingredients of the product and/or chemical composition forming the product, as shown on FIG. 11C, manually. The user may input a single piece of data or the user may input multiple pieces of data. For example, as shown in FIG. 11C, GUI may provide an indication for the user to select the data to be input into the properties engine 630. The user may select a file to provide the ingredient information (via Browse button 1122). Although FIG. 11C shows a Browse button 1122 for inputting data, one of skill in the art will understand that other methods exist for selecting and/or inputting data into properties engine 630, such as via a database (such as a database housed on the cloud), via external hard drives, via external devices (such as user device 502), etc.

The GUI may provide the determined (e.g., predicted) data. For example, the GUI may provide the value of a parameter, as shown in FIG. 11D. The value of the parameter may relate to a product and/or a chemical composition forming a personal care product. Prompt 1130 may display the associated data provided by the user. For example, prompt 1130 may display that the determined data is based on the ingredient information (e.g., the ingredient information provided by the user). Prompt 1130 may indicate what data has been determined. For example, prompt 1130 indicates that the value of the property of the personal care product is being determined. Output 1132 provides the determined value. As shown on FIG. 11D, the determined value may be 1.7. In examples the GUI may provide further information of the information such as that the property is a pH, a fluoride stability, a viscosity stability, an abrasion, a specific gravity, and/or a consumer perception.

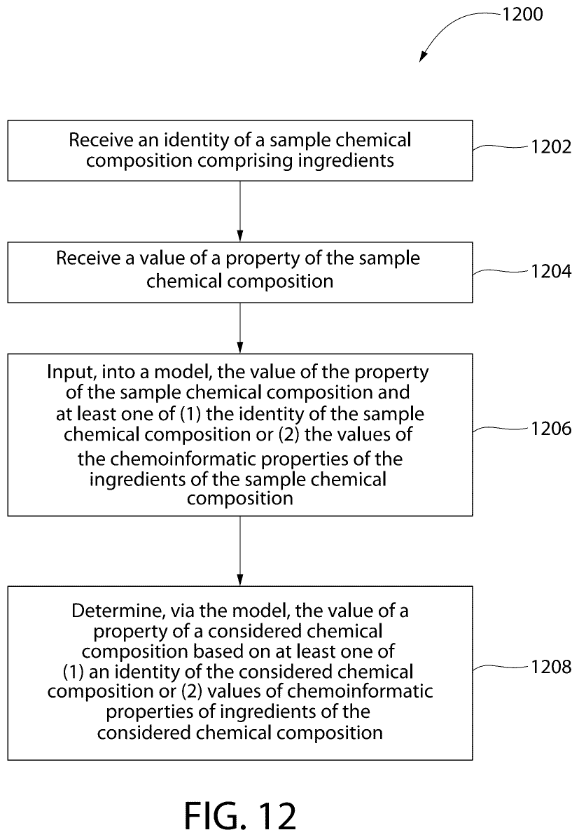

FIG. 12 is an example process 1200 for determining (e.g., predicting) a value of a product and/or chemical composition. The value may be an identity of a product and/or chemical composition, such as a name of the product and/or chemical composition, ingredients of the product and/or chemical composition, chemoinformatic values of ingredients of the product and/or chemical composition, a value of a property of the product and/or chemical composition, etc.

At 1202, an identity of a product and/or chemical composition (e.g., a sample chemical composition) may be received. The identity may be received from a database or another storage device, a described herein. As provided above, the identity of the product and/or chemical composition may be a name of the product and/or chemical composition, ingredients of the product and/or chemical composition, chemoinformatic values of ingredients of the product and/or chemical composition, etc.

At 1204, a value of a parameter of the product and/or chemical composition (e.g., a sample product and/or chemical composition) may be received. The value of the property may be affected by one or more ingredients of the product and/or chemical composition. As an example, the property may be a pH of the chemical composition, and the value of the property may be the value of the pH of the chemical composition.

The identity of the product and/or chemical composition (e.g., the sample chemical composition) and/or the value of the parameter may be used to train a machine learning model, as described herein. For example, at 1206 the value of the property of the product and/or chemical composition (e.g., the sample chemical composition) may be input into the machine learning model to train the machine learning model. An identity of the product and/or chemical composition may be input into the machine learning model to train the machine learning model. The identity of the product and/or chemical composition may be one or more of a name of the product and/or chemical composition, ingredients of the product and/or chemical composition, chemoinformatic values of ingredients of the product and/or chemical composition, etc. The machine learning model may make associations of the value of the property of the product and/or chemical composition and the identity of the product and/or chemical composition.

After the machine learning model is trained, the machine learning model may determine one or more values of a product and/or chemical composition. The machine learning model may determine one or more values of a product and/or chemical composition in response to receiving an associated piece of data. For example, the machine learning model may determine a value of a property of a product and/or chemical composition based on an identity of the product and/or chemical composition, such as ingredients of the product and/or chemical composition or a name of the product and/or chemical composition. The property of the chemical composition may be a pH value of the chemical composition, a fluoride stability value of the chemical composition, a viscosity value of the chemical composition, an abrasion value of the chemical composition, a specific gravity value of the chemical composition, a consumer perception value of a chemical composition, etc.

For example, at 1208 the machine learning model may receive one or more values of a product and/or chemical composition (e.g., a considered product and/or chemical composition). As described herein, a considered product and/or chemical composition may be a product and/or chemical composition in which one or more values are unknown and desired to be known. For example, an identity of a considered product and/or chemical composition may be known, ingredients of the considered product and/or chemical composition may be known, and/or chemoinformatic values of the considered product and/or chemical composition may be known. The value of a property of the considered product and/or chemical composition may be unknown.

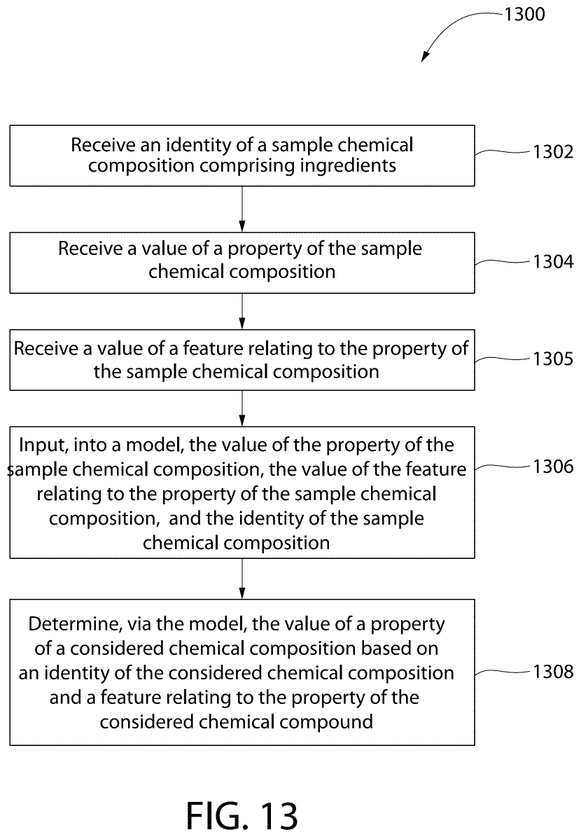

FIG. 13 is an example process 1300 for determining (e.g., predicting) a value of a product and/or chemical composition based on an identity of the product and/or chemical composition and/or a feature relating to the property.

At 1302, an identity of a product and/or chemical composition (e.g., a sample product and/or chemical composition) may be received. The identity may be received from a database or another storage device, a described herein. As provided above, the identity of the product and/or chemical composition may be a name of the product and/or chemical composition, ingredients of the product and/or chemical composition, chemoinformatic values of ingredients of the product and/or chemical composition, etc.

At 1304, a value of a parameter of the product and/or chemical composition (e.g., a sample product and/or chemical composition) may be received. The value of the property may be affected by one or more ingredients of the product and/or chemical composition forming the product. As an example, the property may be a gingivitis reduction, a whitening efficacy, a consumer-perceived liking of a fragrance, etc. The value of the property may be the value identified during a clinical/consumer trial, via a measurement, etc.

At 1305, a value of a feature relating to the value of the product and/or chemical composition may be received. The feature relating to the value of the property may include, for example, a period of time in which a clinical trial of a gingivitis reduction is performed, an age of person in which a clinical whitening efficacy is determined, a demographic of a user providing a consumer-perceived liking of a fragrance, etc. Although these examples describe features determined during a clinical trial, such features of a property may be determined via clinical and/or non-clinical methods, such as via experimentation, measurement, and the like.

At 1306, the value of the property of the product and/or chemical composition (e.g., the sample product and/or chemical composition) and the value of the feature relating to the property may be input into the machine learning model to train the machine learning model. An identity of the product and/or chemical composition may be input into the machine learning model to train the machine learning model. The machine learning model may make associations of values of one or more properties of the product and/or chemical composition, values of one or more features relating to the property, and identities of one or more products and/or chemical compositions.

After the machine learning model is trained, the machine learning model may determine one or more values of the property of the product and/or chemical composition and/or one or more values of features relating to the property. The machine learning model may determine one or more values of a property of the product and/or chemical composition in response to receiving one or more associated pieces of data. For example, the machine learning model may determine a value of a property of a product and/or chemical composition based on an identity of the product and/or chemical composition and/or a feature relating to the property. In examples the property of the product and/or chemical composition forming the product may be a gingivitis reduction, a whitening efficacy, a consumer-perceived liking of a fragrance, etc. In other examples the property of the chemical composition may be a pH value of the chemical composition, a fluoride stability value of the chemical composition, a viscosity value of the chemical composition, an abrasion value of the chemical composition, a specific gravity value of the chemical composition, a clinical/consumer trial, a consumer perception value of a chemical composition, etc.

For example, at 1308 the machine learning model may receive one or more values of a property of a product and/or chemical composition (e.g., a considered/potential product and/or chemical composition) and/or one or more values of features relating to the property of the product and/or chemical composition. As described herein, a considered/potential product and/or chemical composition may be a product and/or chemical composition in which one or more values are unknown and desired to be known. For example, an identity of a considered product and/or chemical composition may be known, ingredients of the considered product and/or chemical composition may be known, chemoinformatic values of the considered product and/or chemical composition may be known, values of features relating to the value of the property may be known, etc. The value of a property of the considered product and/or chemical composition may be unknown.

The known values (e.g., the identity of the considered product and/or chemical composition, ingredients of the considered product and/or chemical composition, chemoinformatic values of the considered product and/or chemical composition, etc.) may be input into the machine learning model. Values of features (e.g., periods of time, user-related information, etc.) relating to the property may be input into the machine learning model. Based on the known values and/or the features being input into the machine learning model, the machine learning model may determine a value of a property of the considered product and/or chemical composition. The value of the considered product and/or chemical composition may be displayed or otherwise provided to a user.

In examples, the user may determine whether the value of the property corresponds to a desired value of the property. For example, it may be desired (e.g., required) that a personal care product have a defined value for a property of the personal care product. The value may relate to a pH value, or one or more other properties described herein. If the machine learning model determines that a product and/or chemical composition has a value of the property that aligns with a desired value of the property, the user may perform an action, such as producing a personal care product having the ingredients associated with the determined value. Values of features relating to the value of a desired property may be modified, for example, to align the value of the property with a desired property. For example, periods of time may be adjusted so that (e.g., until) the value of the property of the chemical composition aligns with a desired value. The user may perform actions to confirm that the results provided by the machine learning model are accurate, such as by performing a measurement of the value of the property, performing mathematically calculations of the value. The user may confirm that the results provided by the machine learning model are accurate before producing a personal care product having the ingredients associated with the determined value.

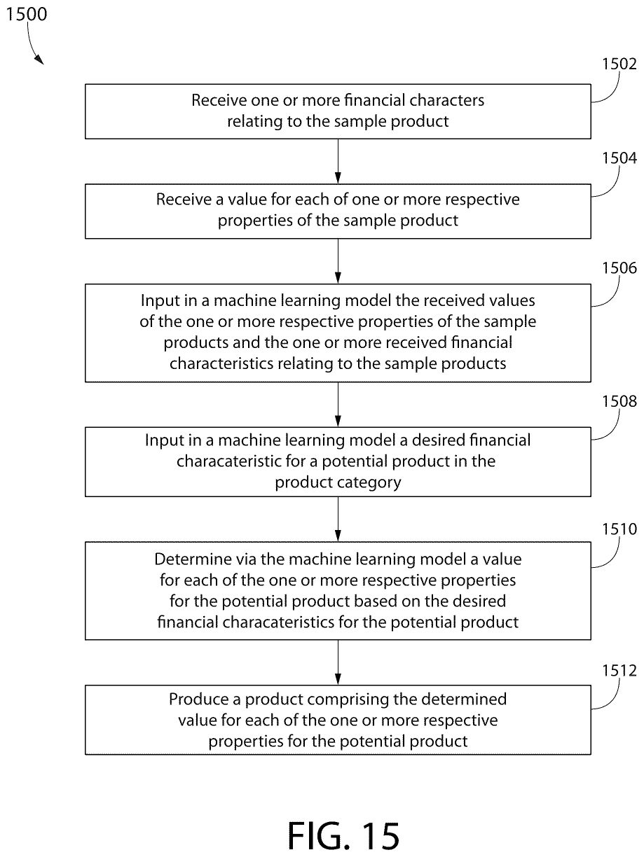

FIG. 15 is an example process 1500 for determining (e.g., predicting) one or more properties of a product (e.g., potential product) based on desired financial characteristics for the considered/potential product. The one or more respective properties of the sample product may include a sensory attribute relating to the sample product or a phrase relating to the sample product, as described herein. Although FIG. 15 describes properties of the product and financial characteristics of the product, these attributes of the product are for illustration purposes only and are not intended to be limiting. Other examples may include product ingredients, financial characteristics, sensory attributes, non-sensory (e.g., word) attributes, and the like.

At 1502, one or more financial characteristics relating to the sample product may be received. The sample product may belong to a product category, as described herein. At 1504, a value for one or more respective properties of the sample product may be received.

At 1506, the received values of the one or more respective properties of the sample products and/or the one or more received financial characteristics relating to the sample products may be input into a model, such as a machine learning model. At 1508, a desired financial characteristic for a potential product may be input into the model. The potential product may be long to a product category that is the same as the product category in which the sample product belongs. At 1510, a value for each of the one or more properties for the potential product may be determined. The value for each of the one or more properties for the potential product may be determined based on the desired financial characteristic for the potential product. At 1512, a product may be produced. The product may be produced having the determined value for each of the one or more respective properties for the potential product. The receiving, inputting, and/or determining steps may be performed by one or more processors, such as one or more processors housed in a server, a mobile device, and the like.

In another aspect, one or more products and/or product portfolios may be determined/predicted using one or more of the techniques described herein. The one or more determined/predicted products may be associated with one or more different product categories. The one or more determined/predicted product portfolios may correspond to one or more product categories (e.g., one or more intra-category product portfolio(s), and/or one or more inter-category product portfolio(s)).

In another aspect, more than one product may be determined/predicted using one or more of the techniques described herein. Producing more than one determined/predicted product that may correspond to a same product category may produce an intra-category product portfolio, for example. Producing more than one determined/predicted product that may correspond to one or more different product categories may produce an inter-category product portfolio, for example.

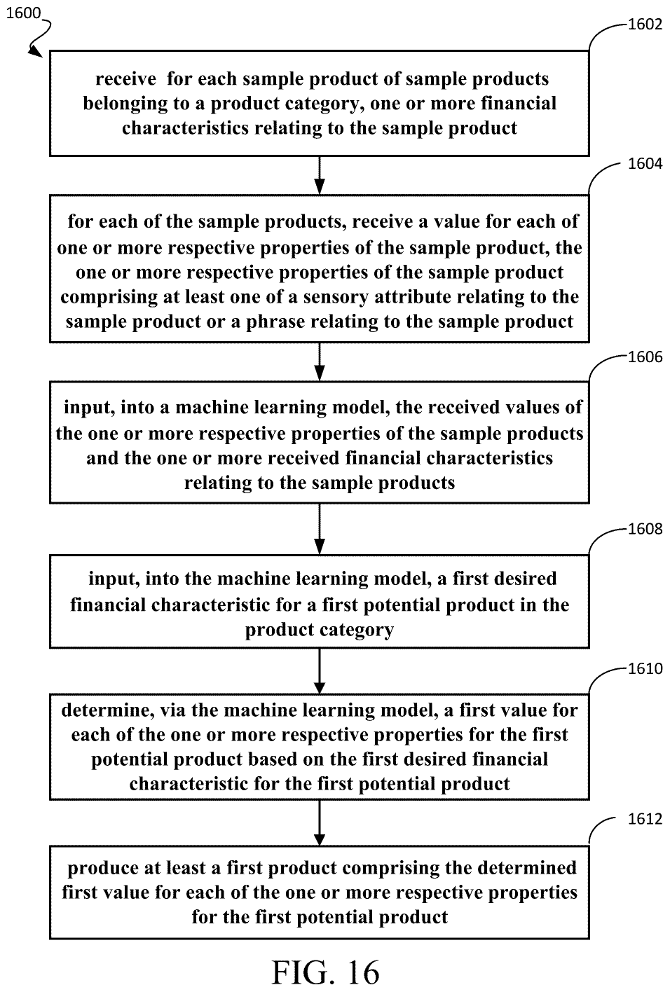

FIG. 16 is an example process 1600 for determining (e.g., predicting) one or more properties of a product (e.g., potential product) based on desired financial characteristics for the considered/potential product. The one or more respective properties of the sample product may include a sensory attribute relating to the sample product or a phrase relating to the sample product, as described herein. Although FIG. 16 describes properties of the product and financial characteristics of the product, these attributes of the product are for illustration purposes only and are not intended to be limiting. Other examples may include product ingredients, financial characteristics, sensory attributes, non-sensory (e.g., word) attributes, and the like.

At 1602, a device may be configured to receive, for each sample product of sample products belonging/corresponding to a product category, one or more financial characteristics relating to the sample product. At 1604, the device may be configured, perhaps for each of the sample products, to receive a value for each of one or more respective properties of the sample product. The one or more respective properties of the sample product may comprise at least one of a sensory attribute relating to the sample product, or a phrase relating to the sample.

At 1606, the device may be configured to receive an input, into at least one machine learning model, the received values of the one or more respective properties of the sample products and the one or more received financial characteristics relating to the sample products. At 1608, the device may be configured to receive an input, into the machine learning model, of a first desired financial characteristic for a first potential product in the product category. At 1610, the device may be configured to determine, via the machine learning model, a first value for each of the one or more respective properties for the first potential product, perhaps based on the first desired financial characteristic for the first potential product. At 1612, the device may be configured to order production of at least a first product and/or the at least a first product may be produced. The product may comprise the determined first value for each of the one or more respective properties for the first potential product. The receiving, inputting, ordering, and/or determining steps may be performed by one or more processors of the device/devices, such as one or more processors housed in a server, a mobile device, and the like.

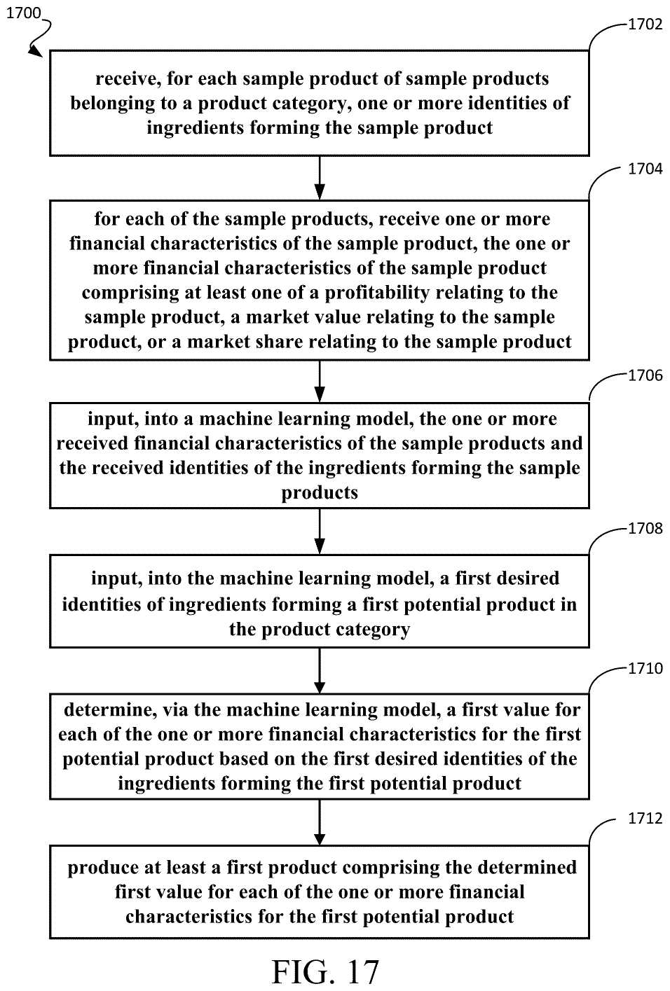

FIG. 17 is an example process 1700 for determining (e.g., predicting) one or more properties of a product (e.g., potential product) based on one or more identities of ingredients forming the considered/potential product. Although FIG. 17 describes ingredients of the product and financial characteristics of the product, these attributes of the product are for illustration purposes only and are not intended to be limiting. Other examples may include properties of the product, financial characteristics, sensory attributes, non-sensory (e.g., word) attributes, and the like.

At 1702, a device may be configured to receive, for each sample product of sample products belonging to a product category, one or more identities of ingredients forming the sample product. At 1704, the device may be configured, perhaps for each of the sample products, to receive one or more financial characteristics of the sample product. The one or more financial characteristics of the sample product may comprise at least one of a profitability relating to the sample product, a market value relating to the sample product, and/or a market share relating to the sample.

At 1706, the device may be configured to receive an input, into a machine learning model, the one or more received financial characteristics of the sample products and the received identities of the ingredients forming the sample products. At 1708, the device may be configured to receive an input, into the machine learning model, of a first desired identities of ingredients forming a first potential product in the product category. At 1710, the device may be configured to determine, via the machine learning model, a first value for each of the one or more financial characteristics for the first potential product, perhaps based on the first desired identities of the ingredients forming the first potential product. At 1712, the device may be configured to order production of at least a first product and/or the at least a first product may be produced. The product may comprise the determined first value for each of the one or more financial characteristics for the first potential product. The receiving, inputting, ordering, and/or determining steps may be performed by one or more processors of the device/devices, such as one or more processors housed in a server, a mobile device, and the like.

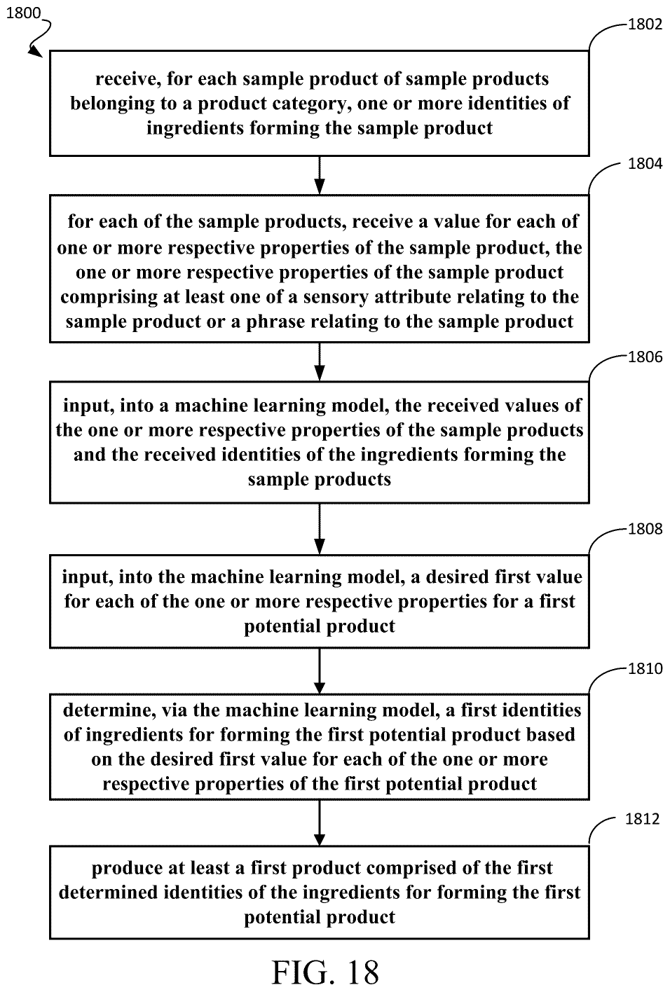

FIG. 18 is an example process 1800 for determining (e.g., predicting) one or more properties of a product (e.g., potential product) based on one or more identities of ingredients forming the considered/potential product. Although FIG. 18 describes ingredients of the product and financial characteristics of the product, these attributes of the product are for illustration purposes only and are not intended to be limiting. Other examples may include properties of the product, financial characteristics, sensory attributes, non-sensory (e.g., word) attributes, and the like.

At 1802, a device may be configured to receive, for each sample product of sample products belonging to a product category, one or more identities of ingredients forming the sample. At 1804, the device may be configured, perhaps for each of the sample products, to receive a value for each of one or more respective properties of the sample product. The one or more respective properties of the sample product may comprise at least one of a sensory attribute relating to the sample product and/or a phrase relating to the sample product.

At 1806, the device may be configured to receive an input, into a machine learning model, of the received values of the one or more respective properties of the sample products and the received identities of the ingredients forming the sample products. At 1808, the device may be configured to receive an input, into the machine learning model, of a desired first value for each of the one or more respective properties for a first potential product. At 1810, the device may be configured to determine, via the machine learning model, a first identities of ingredients for forming the first potential product, perhaps based on the desired first value for each of the one or more respective properties of the first potential product. At 1812, the device may be configured to order production of at least a first product and/or the at least a first product may be produced. The first product may comprise the first determined identities of the ingredients for forming the first potential product. The receiving, inputting, ordering, and/or determining steps may be performed by one or more processors of the device/devices, such as one or more processors housed in a server, a mobile device, and the like.

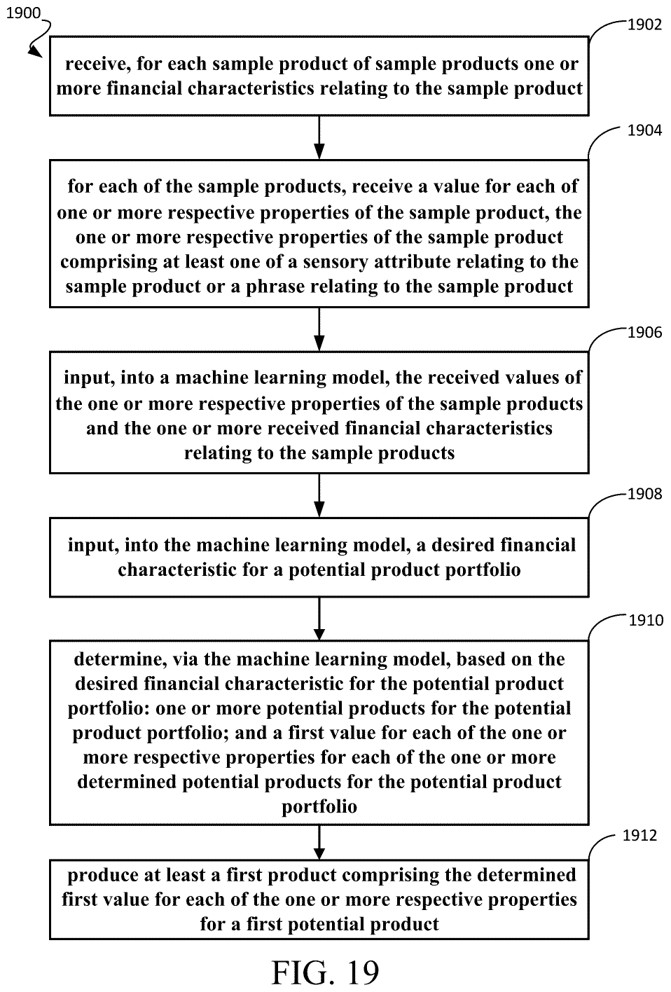

FIG. 19 is an example process 1900 for determining (e.g., predicting) one or more properties of a product (e.g., potential product) based on one or more financial characteristics relating to a sample product. Although FIG. 19 describes ingredients of the product and financial characteristics of the product, these attributes of the product are for illustration purposes only and are not intended to be limiting. Other examples may include properties of the product, financial characteristics, sensory attributes, non-sensory (e.g., word) attributes, and the like.

At 1902, a device may be configured to receive, for each sample product of sample products one or more financial characteristics relating to the sample product. At 1904, the device may be configured, perhaps for each of the sample products, to receive a value for each of one or more respective properties of the sample product. The one or more respective properties of the sample product may comprise at least one of a sensory attribute relating to the sample product and/or a phrase relating to the sample product.

At 1906, the device may be configured to receive an input, into a machine learning model, of the received values of the one or more respective properties of the sample products and the one or more received financial characteristics relating to the sample products. At 1908, the device may be configured to receive an input, into the machine learning model, of a desired financial characteristic for a potential product portfolio. At 1910, the device may be configured to determine, via the machine learning model, perhaps based on the desired financial characteristic for the potential product portfolio one or more potential products for the potential product portfolio, and/or a first value for each of the one or more respective properties for each of the one or more determined potential products for the potential product portfolio. At 1912, the device may be configured to order production of at least a first product and/or the at least a first product may be produced. The first product may comprise the determined first value for each of the one or more respective properties for a first potential product. The receiving, inputting, ordering, and/or determining steps may be performed by one or more processors of the device/devices, such as one or more processors housed in a server, a mobile device, and the like.

Systems described herein may be implemented using any available computer system and adaptations contemplated for known and later developed computing platforms and hardware. Further, the methods described herein may be carried out by software applications configured to execute on computer systems ranging from single-user workstations, client server networks, large distributed systems employing peer-to-peer techniques, or clustered grid systems. In an example, a high-speed computing cluster may be used. The computer systems used to practice the methods described herein may be geographically dispersed across local or national boundaries using a data communications network such as the Internet. Moreover, predictions generated at one location may be transported to other locations using well known data storage and transmission techniques, and predictions may be verified experimentally at the other locations.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A computer-implemented method comprising:
for each sample chemical composition of sample chemical compositions, inputting into a first model:
chemoinformatic properties of ingredients of the sample chemical composition; and
a value of a property of the sample chemical composition;
determining, via the first model, a new chemical composition based on:
the chemoinformatic properties of the ingredients of the sample chemical compositions; and
the values of the properties of the sample chemical compositions;
inputting into a second model:
for each sample product of sample products, a value for one or more visual properties of a packaging of the sample product; and
one or more characteristics of the new chemical composition;
determining, via the second model, a value for each of the one or more visual properties of a packaging for the new chemical composition, the determination based on:
the values of the visual properties of the packaging sample products; and
the one or more characteristics of the new chemical composition;
producing a first product comprising:
the new chemical composition; and
packaging comprising the values for each of the one or more visual properties of the packing for the new chemical composition.

2. The method of claim 1 wherein the one or more visual properties comprise a color of the packaging of the sample product.

3. The method of claim 1 wherein the one or more visual properties comprise a phrase on the packaging of the sample product.

4. The method of claim 1 wherein the one or more visual properties comprise a text on the packaging of the sample product.

5. The method of claim 1 wherein the one or more characteristics of the new chemical composition comprise a product category, an ingredient, or a flavor.

6. The method of claim 1 wherein the one or more characteristics of the new chemical composition comprise a financial characteristic.

7. The method of claim 1 wherein the sample product is at least one of a personal care product, a foodstuff, or a pharmaceutical.

8. The method of claim 1 wherein the sample products correspond to a single product category.

9. The method of claim 8 wherein the product category is oral care, skin care, or hair care.

10. The method of claim 1 wherein the sample products are toothpastes or toothbrushes, and at least one of the first model and the second model is a machine learning model.

11. A computer-implemented method comprising:
training a first model using, for each sample chemical composition of sample chemical compositions:
identities of ingredients of the sample chemical composition; and
a value of a property of the sample chemical composition;
inputting into the first model identities of ingredients of a proposed chemical composition;
determining, via the first model, a value of the property for the proposed chemical composition;
inputting into a second model:
for each sample product of sample products, a value for one or more visual properties of a packaging of the sample product; and
one or more characteristics of the proposed chemical composition;
determining, via the second model, a value for each of the one or more visual properties of a packaging for the proposed chemical composition, the determination based on:
the values of the visual properties of the packaging sample products; and
the one or more characteristics of the new chemical composition;
producing a first product comprising:
the new chemical composition; and
packaging comprising the values for each of the one or more visual properties of the packing for the new chemical composition.

12. The method of claim 11 wherein the one or more visual properties comprise a color of the packaging of the sample product.

13. The method of claim 11 wherein the one or more visual properties comprise a phrase on the packaging of the sample product.

14. The method of claim 11 wherein the one or more visual properties comprise a text on the packaging of the sample product.

15. The method of claim 11 wherein the one or more characteristics of the proposed chemical composition comprise a product category, an ingredient, or a flavor.

16. The method of claim 11 wherein the one or more characteristics of the proposed chemical composition comprise a financial characteristic.

17. The method of claim 11 wherein the sample product is at least one of a personal care product, a foodstuff, or a pharmaceutical.

18. The method of claim 11 wherein the sample products correspond to a single product category.

19. The method of claim 18 wherein the product category is oral care, skin care, or hair care.

20. The method of claim 11 wherein the sample products are toothpastes or toothbrushes, and at least one of the first model and the second model is a machine learning model.
